(19) United States
(12) Patent Application Publication
(10) Pub. No.: US 2024/0332236 A1
(43) Pub. Date: Oct. 3, 2024

(54) SEMICONDUCTOR DEVICE, INTEGRATED CIRCUIT DEVICE, AND METHOD

(71) Applicant: TAIWAN SEMICONDUCTOR MANUFACTURING COMPANY, LTD., Hsinchu (TW)

(72) Inventors: Shenggao LI, Hsinchu (TW); Chien-Chun TSAI, Hsinchu (TW)

(21) Appl. No.: 18/194,709

(22) Filed: Apr. 3, 2023

(51) Int. Cl. H01L 23/00; G06F 30/392; H01L 21/48; H01L 21/56; H01L 23/31; H01L 23/538

(52) U.S. Cl. CPC H01L 24/14; G06F 30/392; H01L 21/4853; H01L 21/4857; H01L 21/565; H01L 23/3128; H01L 23/5381; H01L 23/5383; H01L 23/5386; G06F 2119/18; H01L 2224/14131; H01L 2224/1451

(57) ABSTRACT

A semiconductor device includes a set of external connectors arranged in a plurality of columns and rows. The set of external connectors comprises receiver connectors and transmitter connectors correspondingly configured to input and output information into and from the semiconductor device. The receiver connectors comprise: a first receiver connector group of first consecutive receiver connectors, and a second receiver connector group of second consecutive receiver connectors. The transmitter connectors comprise: a first transmitter connector group of first consecutive transmitter connectors, and a second transmitter connector group of second consecutive transmitter connectors. The first receiver connector group, the second receiver connector group, the first transmitter connector group, and the second transmitter connector group are arranged with respect to each other along a column direction of the plurality of columns.

### BACKGROUND

The semiconductor industry has experienced rapid growth due to ongoing improvements in integration density of a variety of components (e.g., photoelectric devices, electrical components, or the like). To accommodate the miniaturized scale of semiconductor devices (also referred to herein as dies), various technologies and applications are developed for wafer-level packaging, involving greater numbers of different components with different functions. An approach is to use interconnect structures to couple multiple dies for the purposes of fitting more processing capability in smaller packages.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of an integrated circuit (IC) device, in accordance with some embodiments.

FIGS. 2A and 2B are enlarged schematic plan views showing various external connector arrangements for input/output (I/O) ports of semiconductor devices, in accordance with some embodiments.

FIGS. 2C and 2D are enlarged schematic plan views of various sections of one or more interconnect structures, in accordance with some embodiments.

FIG. 3A is a schematic plan view of an I/O port of a semiconductor device, in accordance with some embodiments.

FIG. 3B is a schematic plan view of an I/O port with a reduced bandwidth compared to the I/O port in FIG. 3A, in accordance with some embodiments.

FIG. 3C is a schematic plan view showing generation of a bump map of an I/O port with reduced bandwidth from a bump map of the I/O port in FIG. 3A, in accordance with some embodiments.

FIGS. 4A-4D are schematic plan views of various IC devices, in accordance with some embodiments.

FIGS. 5A-5B are schematic views of various bump maps for I/O ports of semiconductor devices, in accordance with some embodiments.

FIG. 6 is a schematic cross-sectional view of a portion of a semiconductor device, in accordance with some embodiments.

FIGS. 7A-7G are schematic cross-sectional views of an IC device at various stages in a manufacturing process, in accordance with some embodiments.

FIG. 8 is a flowchart of a method, in accordance with some embodiments.

FIG. 9 is a block diagram of an electronic design automation (EDA) system in accordance with some embodiments.

FIG. 10 is a block diagram of an IC device manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components, materials, values, steps, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above.” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Source/drain(s) may refer to a source or a drain, individually or collectively dependent upon the context.

In a semiconductor package (also referred to in one or more embodiments as an integrated circuit (IC) device), two adjacently placed dies are coupled to each other by an interconnect structure. Each die has an input/output (I/O) port (also referred to as an I/O module or I/O interface). The I/O port comprises a plurality of external connectors via which the die is coupled to the interconnect structure. The external connectors comprise receiver connectors and transmitter connectors correspondingly for receiving and transmitting information from/to the other die via the interconnect structure.

In some embodiments, in an I/O port of a semiconductor device or die, the receiver connectors are grouped into a plurality of receiver connector groups, and the transmitter connectors are grouped into a plurality of corresponding transmitter connector groups. As a result, in at least one embodiment, it is possible to reconfigure the I/O port to have a desired bandwidth matching the bandwidth of the I/O port of the other die, by enabling or disabling a number of receiver connector groups and corresponding transmitter connector groups. In at least one embodiment, it is possible to generate a new arrangement of external connectors (also referred to in one or more embodiments as a bump map) for an I/O port, by simply replicating a desired number of receiver connector groups and corresponding transmitter connector groups of an existing bump map into the new bump map. In some embodiments, the grouping of the receiver connectors and transmitter connectors into corresponding groups improves interoperability between I/O ports of different form factors, packages, or bandwidths, which are advantages over other approaches. Some embodiments achieve one or more further advantages over other approaches, including, but not limited to, better routing, better signal integrity, more uniform placement of external connectors, better wire density distribution, better clock placement, or the like.

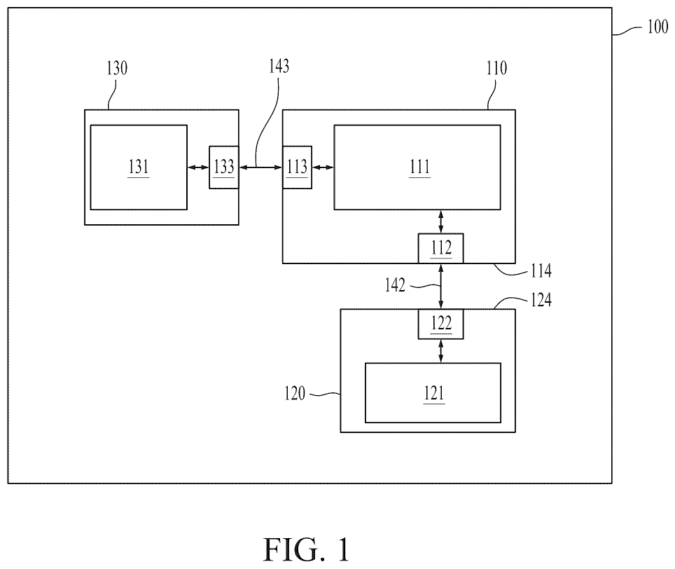

FIG. 1 is a block diagram of an integrated circuit (IC) device 100, in accordance with some embodiments.

The IC device 100 comprises dies 110, 120, 130. In some embodiments, the dies 110, 120, 130 are also referred to as chips, cores, or the like. Each die comprises a functional circuit, and one or more I/O ports. For example, the die 110 comprises a functional circuit 111, and I/O ports 112, 113. The die 120 comprises a functional circuit 121, and an I/O port 122. The I/O ports 112, 122 are arranged along facing edges 114, 124 of the dies 110, 120, and are coupled to each other by an interconnect structure schematically designated at 142. The die 130 comprises a functional circuit 131, and an I/O port 133. The I/O ports 113, 133 are arranged along facing edges (not numbered) of the dies 110, 130, and are coupled to each other by another interconnect structure 143. The described numbers and/or physical arrangements of dies and/or I/O ports in each die are examples. Other configurations are within the scopes of various embodiments. For example, in at least one embodiment, the die 110 comprises another I/O port (not shown) along the same edge 114 as the I/O port 112, and configured to be coupled to another die (not shown).

Each of the functional circuits 111, 121, 131 comprises a plurality of circuit elements electrically coupled together to perform one or more operations and/or functionality of the corresponding dies 110, 120, 130. Examples of circuit elements include, but are not limited to, transistors and diodes. Examples of transistors include, but are not limited to, metal oxide semiconductor field effect transistors (MOSFET), complementary metal oxide semiconductors (CMOS) transistors, P-channel metal-oxide semiconductors (PMOS), N-channel metal-oxide semiconductors (NMOS), bipolar junction transistors (BJT), high voltage transistors, high frequency transistors, P-channel and/or N-channel field effect transistors (PFETs/NFETs), FinFETs, planar MOS transistors with raised source/drains, nanosheet FETs, nanowire FETs, or the like. In some embodiments, the dies 110, 120, 130 are different or similar chips with corresponding operations and/or functionality performed by the corresponding functional circuits 111, 121, 131. Examples of chips or cores include, but are not limited to, central processing units (CPUs), graphics processing units (GPUs), accelerated processing units (APUs), memory controllers, motherboard controllers, bridge devices, I/O devices for communication with other IC devices, or the like.

The I/O ports 112, 122, 113, 133 are configured to exchange information among the dies 110, 120, 130. A pair of I/O ports that are coupled to one another corresponds to a same protocol. For example, the pair of I/O ports 112, 122 corresponds to the same, first protocol, and the pair of I/O ports 113, 133 corresponds to the same, second protocol which may be the same as or different from the first protocol. In at least one embodiment, the pair of I/O ports 112, 122 and/or the pair of I/O ports 113, 133 correspond to the Universal Chiplet Interconnect express (UCIe) protocol. Other protocols for interconnecting multiple chips are within the scopes of various embodiments. Examples of the interconnect structures 142, 143 include, but are not limited to, local silicon interconnects (LSIs, also referred to as silicon bridges), interposers, fanout organic interposers, redistribution layers (RDLs), or the like.

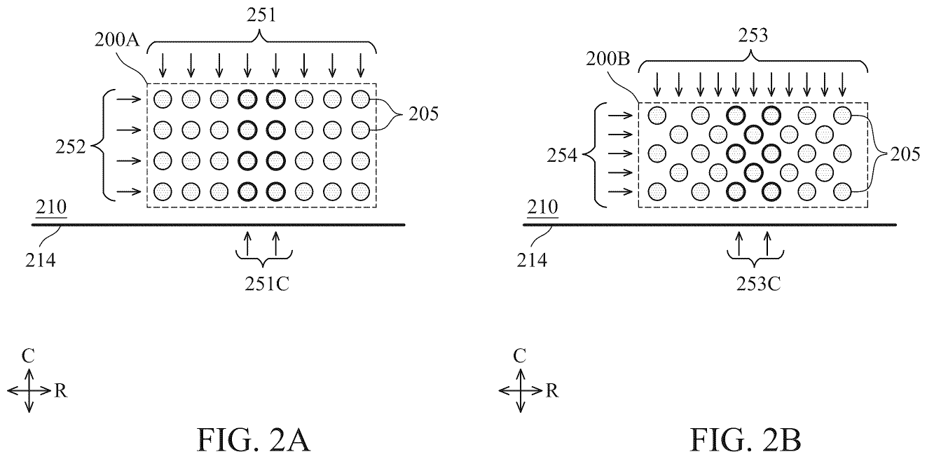

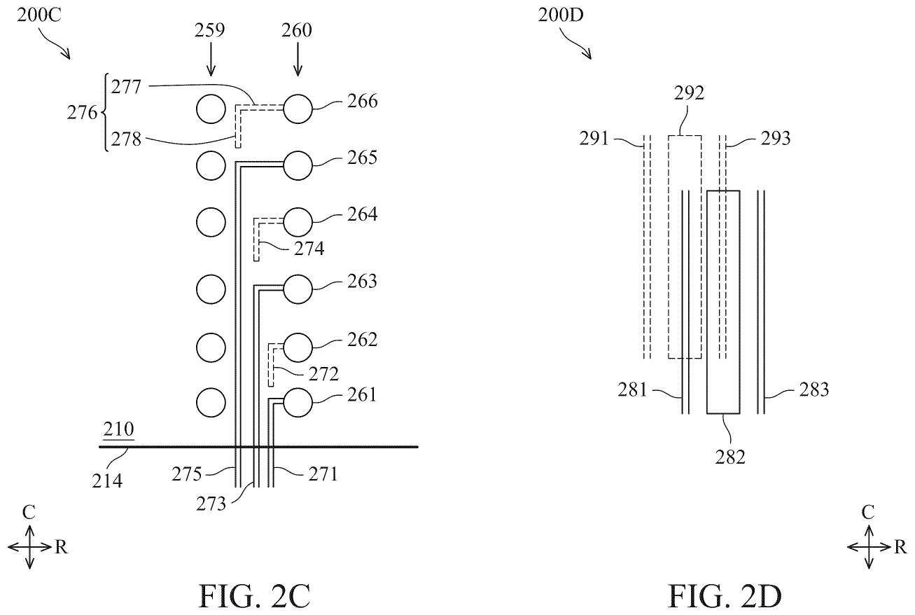

FIG. 2A is an enlarged schematic plan view showing an example external connector arrangement for an I/O port 200A, in accordance with some embodiments.

In some embodiments, the I/O port 200A corresponds to any one of the I/O ports 112, 122, 113, 133. For example, the I/O port 200A corresponds to the I/O port 112 and is arranged along an edge 214 of a semiconductor device 210, the semiconductor device 210 corresponds to the die 110, and the edge 214 corresponds to the edge 114.

The I/O port 200A comprises a set of external connectors 205. For simplicity, external connectors are sometimes referred to herein in one or more embodiments as bumps. Examples of external connectors include, but are not limited to, solder balls, ball grid array (BGA) connectors, micro bumps (e.g., u bumps), controlled collapse chip connection (C4) bumps, or the like. Other configurations for external connectors are within the scopes of various embodiments.

In the I/O port 200A, external connectors 205 are arranged in a non-staggering manner in a plurality of columns 251 and a plurality of rows 252. In this non-staggering arrangement, each of the columns 251 includes the same number of external connectors 205, and each of the rows 252 includes the same number of external connectors 205. The columns 251 extend along a column direction C, and the rows 252 extend along a row direction R. The row direction R and the rows 252 extend along the edge 214 of the semiconductor device 210. The column direction C and the columns 251 extend transversely to the edge 214. In at least one embodiment, the rows 252 are parallel to the edge 214 and/or the columns 251 are perpendicular to the edge 214. The columns 251 include one or more central columns at the center of the I/O port 200A along the row direction R. In the example configuration in FIG. 2A, the I/O port 200A includes an even number of columns 251 which include an even number, e.g., two, of central columns 251C. In at least one embodiment where the I/O port 200A includes an odd number of columns 251, there is an odd number of central columns. The described numbers of external connectors 205, columns 251, rows 252 and/or central columns 251C are examples. Other configurations are within the scopes of various embodiments.

FIG. 2B is an enlarged schematic plan view showing a further example external connector arrangement for an I/O port 200B, in accordance with some embodiments. For simplicity, corresponding elements in FIGS. 2A and 2B are designated by the same reference numerals.

The I/O port 200B is different from the I/O port 200A in that external connectors 205 in the I/O port 200B are arranged in a staggering manner. Specifically, the external connectors 205 in the I/O port 200B are arranged in a plurality of columns 253 along the column direction C, and a plurality of rows 254 along the row direction R. In this staggering arrangement, odd columns and even columns among the columns 253 include different numbers of external connectors 205, and odd rows and even rows among the rows 254 include different numbers of external connectors 205. The rows 254 extend along the edge 214 of the semiconductor device 210, and the columns 253 extend transversely to the edge 214. In at least one embodiment, the rows 254 are parallel to the edge 214 and/or the columns 253 are perpendicular to the edge 214. The columns 253 include one or more central columns at the center of the I/O port 200B along the row direction R. In the example configuration in FIG. 2B, the I/O port 200B includes an odd number of columns 253 which include an odd number, e.g., three, of central columns 253C. In at least one embodiment where the I/O port 200B includes an even number of columns 253, there is an even number of central columns. The described numbers of external connectors 205, columns 253, rows 254 and/or central columns 253C are examples. Other configurations are within the scopes of various embodiments.

The external connectors of an I/O port, such as the I/O port 200A or I/O port 200B, are configured to transmit and receive different data and/or signals including, but not limited to, main band data, side band data, power, clock, track, valid, or the like. The external connectors of the I/O port of one die are to be coupled to corresponding external connectors of an I/O port of another die by corresponding conductive traces, also referred to as lanes, provided by an interconnect structure as described herein. For example, the main band data are transmitted and/or received via main band data lanes, the side band data are transmitted and/or received via side band data lanes, or the like. Several lane configurations are described with respect to FIGS. 2C, 2D.

The main band data lanes are configured to provide the main data path between the coupled dies. The number of main band data lanes included in the main data path corresponds to a bandwidth of the connection between the dies. For example, an X64 connection between two dies corresponds to 64 main band data lanes from one die to the other, for a total of 128 main band data lanes. In this X64 example, the I/O port of each die includes 64 main band data external connectors configured to transmit main band data to the other die, and 64 main band data external connectors configured to receive main band data from the other die. For simplicity, main band data external connectors configured to transmit main band data are referred to herein as transmitter connectors, and main band data external connectors configured to receive main band data are referred to herein as receiver connectors. The 64 transmitter connectors of one die are correspondingly coupled by corresponding 64 main band data lanes to the 64 receiver connectors of the other die, and vice versa. In an example X32 connection between two dies, the I/O port of each die includes 32 transmitter connectors and 32 receiver connectors, and the 32 transmitter connectors of one die are correspondingly coupled by corresponding 32 main band data lanes to the 32 receiver connectors of the other die, and vice versa. In an example X16 connection between two dies, the I/O port of each die includes 16 transmitter connectors and 16 receiver connectors, and the 16 transmitter connectors of one die are correspondingly coupled by corresponding 16 main band data lanes to the 16 receiver connectors of the other die, and vice versa. The described X64, X62, X16 connections are example. Other connections with different bandwidths and/or numbers of main band data lanes are within the scopes of various embodiments.

In some embodiments, side band data lanes are configured for parameter exchanges, link training, link management, debug, compliance, or the like. Power lanes are configured for providing power supply and/or ground voltages, or the like. Clock lanes are configured for clock signal distribution, synchronization, or the like. Track and valid lanes are configured correspondingly for tracking and valid signals. In some embodiments, one or more external connectors of an I/O port are redundancy external connectors configured to establish one or more redundance lanes for repairing, if necessary, one or more defective main band data lanes, side band data lanes, or the like. In some embodiments, one or more of the described external connectors for side band data, power, clock, track, valid, redundancy/repair, or the like are omitted in an I/O port.

FIG. 2C is an enlarged schematic plan view of a section of an interconnect structure 200C, in accordance with some embodiments.

The interconnect structure 200C is configured to couple a first I/O port of a first semiconductor device to a second I/O port of a second semiconductor device. The interconnect structure 200C comprises a first set of external connectors being a mirror image of the set of external connectors of the first I/O port of the first semiconductor device, and a second set of external connectors being a mirror image of the set of external connectors of the second I/O port of the second semiconductor device. In the example configuration in FIG. 2C, a section of the first set of external connectors of the interconnect structure 200C, which is configured to be coupled to the I/O port 200A, is shown. Specifically, the interconnect structure 200C comprises a plurality of external connectors arranged in columns and rows in a mirror image of the columns 251 and rows 252 of the I/O port 200A. For example, two adjacent columns 259, 260 of external connectors of the interconnect structure 200C are shown in FIG. 2C, and correspond to two adjacent columns among the columns 251 of the I/O port 200A.

The interconnect structure 200C further comprises a plurality of metal layers including a plurality of conductive traces, or lanes, correspondingly coupling the external connectors in FIG. 2C to corresponding external connectors of the second set (not shown) of external connectors to be coupled to another die. For example, the interconnect structure 200C comprises lanes 271-276 correspondingly coupled to external connectors 261-266 in the column 260. The lanes 271-276 all extend across the adjacent edge 214 of the semiconductor device 210, and further toward the other semiconductor device. However, for simplicity, lanes 272, 274, 276 are not illustrated in FIG. 2C to show that they extend across the adjacent edge 214.

Each lane comprises a first section along the row direction R, and a second section along the column direction C. For example, the lane 276 comprises a first section 277 along the row direction R. and a second section 278 along the column direction C. The first section and second section of a lane are not necessarily formed in the same metal layer in the interconnect structure 200C. In an example, the first section 277 comprises one or more conductive patterns in one or more metal layers and/or one or more vias to couple the external connector 266 to a beginning of the second section 278. The second section, e.g., 278, of each lane is significantly longer than the corresponding first section, e.g., 277, and defines the effective length of the lane over which signals travel between the coupled semiconductor devices (or dies). In some embodiments, the second sections of all main band data lanes are configured to have the same, or substantially the same, length, to ensure a uniform signal delay across all main band data lanes. For simplicity, unless otherwise specified herein, when a lane is described, it is the second section (along the column direction C) of the lane that is described.

In the example configuration in FIG. 2C, the lanes 271, 273, 275 (i.e., the second sections thereof) are formed in a first metal layer of the interconnect structure 200C, and the lanes 272, 274, 276 (i.e., the second sections thereof) are formed in a second metal layer of the interconnect structure 200C. The second metal layer is under the first metal layer. The number of lanes formable in each metal layer of the interconnect structure 200C depends on various design rules including, but not limited to, via enclosure, via diameter, metal width, metal pitch, bump pitch between adjacent columns of external connectors, or the like. Given a number of lanes to be formed to couple the external connectors in a column to the other semiconductor device and the number of lanes formable in each metal layer, it is possible to determine the number of metal layers required in the interconnect structure 200C to form the lanes. In some embodiments, by spreading the required number of lanes to be formed for an I/O port across all columns, it is possible to reduce the number of metal layers required in the corresponding interconnect structure for forming the lanes, thereby reducing manufacturing cost and/or manufacturing time.

FIG. 2D is an enlarged schematic plan view of a section of an interconnect structure 200D, in accordance with some embodiments. In some embodiments, the interconnect structure 200D is the same as the interconnect structure 200C, i.e., FIGS. 2C and 2D illustrate various sections of the same interconnect structure.

In the example configuration in FIG. 2D, the interconnect structure 200D comprises lanes 281-283 in one metal layer, and lanes 291-293 in another metal layer. The lanes 281, 283, 291, 293 are main band data lanes, the lanes 282, 292 are power lanes and are wider than the main band data lanes 281, 283, 291, 293. Each of the power lanes 282, 292 is configured to carry a power supply voltage, or a ground voltage. In some embodiments, the power lanes 282, 292 are configured to carry the same voltage, e.g., both power lanes 282, 292 are configured to carry the power supply voltage, or both power lanes 282, 292 are configured to carry the ground voltage. In at least one embodiment, the power lanes 282, 292 are configured to carry different voltages, e.g., one of the power lanes 282, 292 is configured to carry the ground voltage whereas the other power lane is configured to carry the power supply voltage.

The power lane 282 is arranged between the main band data lanes 281, 283, and overlaps, in a thickness direction of the interconnect structure 200D, the main band data lane 293. The power lane 292 is arranged between the main band data lanes 291, 293, and overlaps, in the thickness direction, the main band data lane 281. In some embodiments, the arrangement of a power lane between adjacent main band data lanes in the same metal layer and/or overlapping a main band data lane in another metal layer provides a shielding effect that reduces crosstalk between adjacent main band data lanes and improves signal integrity.

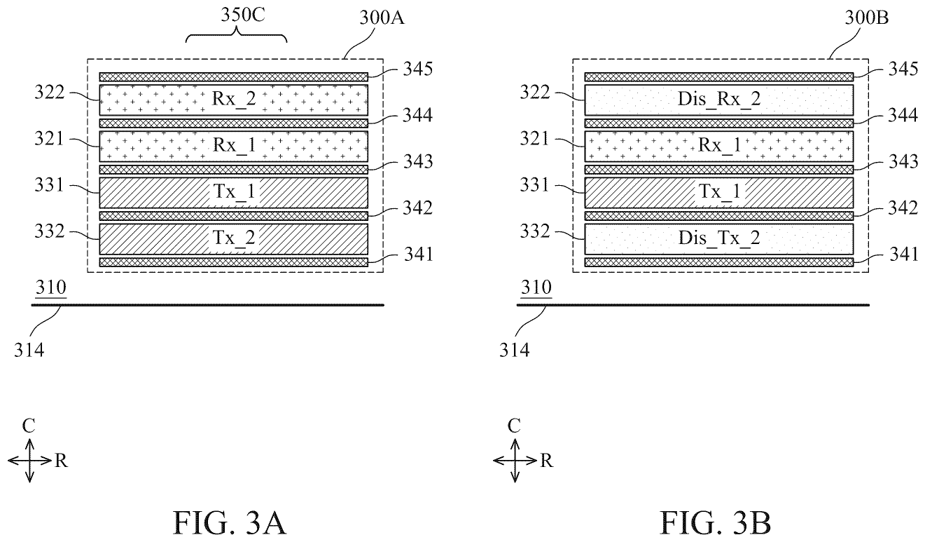

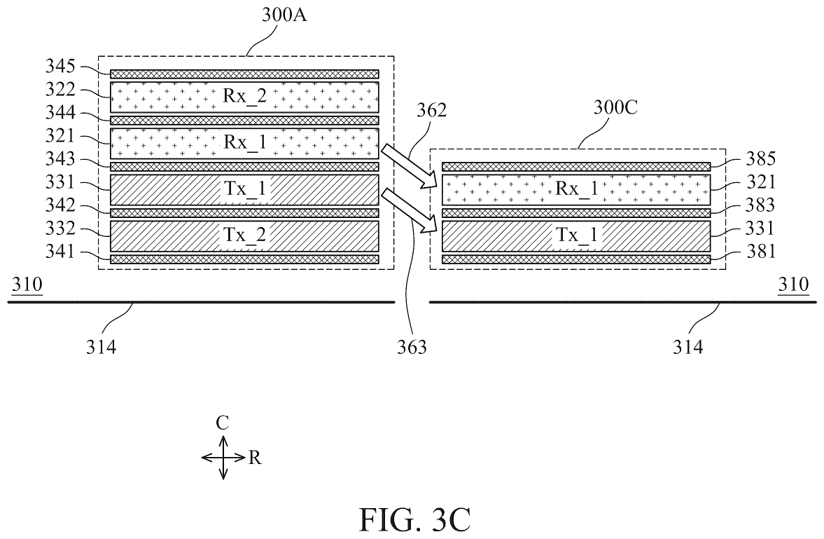

FIG. 3A is a schematic plan view of an I/O port 300A of a semiconductor device, in accordance with some embodiments.

In some embodiments, the I/O port 300A corresponds to any one of the I/O ports 112, 122, 113, 133. For example, the I/O port 300A corresponds to the I/O port 112 and is arranged along an edge 314 of a semiconductor device 310, the semiconductor device 310 corresponds to the die 110, and the edge 314 corresponds to the edge 114. The I/O port 300A comprises a set of external connectors for main band data, and for one or more of side band data, power, clock, track, valid, redundancy/repair, or the like, as described herein. In some embodiments, the external connectors of the I/O port 300A are arranged in a non-staggering manner as described with respect to the I/O port 200A. In one or more embodiments, the external connectors of the I/O port 300A are arranged in a staggering manner as described with respect to the I/O port 200B.

The set of external connectors of the I/O port 300A comprises a plurality of receiver connectors and a plurality of transmitter connectors correspondingly configured to input and output information into and from the semiconductor device 310. The plurality of receiver connectors and the plurality of transmitter connectors of the I/O port 300A are grouped into a number of groups. In the example configuration in FIG. 3A, the plurality of receiver connectors of the I/O port 300A comprises a first receiver connector group Rx_1 and a second receiver connector group Rx_2, and the plurality of transmitter connectors of the I/O port 300A comprises a first transmitter connector group Tx_1 and a second transmitter connector group Tx_2. The first receiver connector group Rx_1, the second receiver connector group Rx_2, the first transmitter connector group Tx_1, and the second transmitter connector group Tx_2 are arranged with respect to each other along the column direction C.

The first receiver connector group Rx_1 comprises first receiver connectors, and the second receiver connector group Rx_2 comprises second receiver connectors. For example, the first receiver connector group Rx_1 comprises k receiver connectors, and the second receiver connector group Rx_2 comprises/receiver connectors, where k+l is the total number of all receiver connectors of the I/O port 300A. The k receiver connectors in the first receiver connector group Rx_1 correspond to the first k bits of data to be received by the semiconductor device 310, and the/receiver connectors in the second receiver connector group Rx_2 correspond to the subsequent l bits of data to be received by the semiconductor device 310. For example, the k receiver connectors in the first receiver connector group Rx_1 correspond to bit 0 to bit (k−1), and the/receiver connectors in the second receiver connector group Rx_2 correspond to bit k to bit (k+l−1). In other words, the first receiver connector group Rx_1 comprises k consecutive receiver connectors, and the second receiver connector group Rx_2 comprises l consecutive receiver connectors which are consecutive to the k consecutive receiver connectors of the first receiver connector group Rx_1. In some embodiments, k is equal to l, i.e., the first receiver connector group Rx_1 and the second receiver connector group Rx_2 includes the same number of receiver connectors. In at least one embodiment, k is different from l. In some embodiments, for an X64 connection between the semiconductor device 310 and another semiconductor device, k=l=32. For an X32 connection between the semiconductor device 310 and another semiconductor device, k=l=16. For an X16 connection between the semiconductor device 310 and another semiconductor device, k=l=8. The described numbers of receiver connector groups and/or numbers of receiver connectors per receiver connector group are example. Other configurations are within the scopes of various embodiments.

The first transmitter connector group Tx_1 comprises first transmitter connectors corresponding to the first receiver connectors in the first receiver connector group Rx_1, and the second transmitter connector group Tx_2 comprises second transmitter connectors corresponding to the second receiver connectors in the second receiver connector group Rx_2. For example, where the first receiver connector group Rx_1 comprises k receiver connectors and the second receiver connector group Rx_2 comprises l receiver connectors, the first transmitter connector group Tx_1 comprises k transmitter connectors and the second transmitter connector group Tx_2 comprises/transmitter connectors. The k transmitter connectors in the first transmitter connector group Tx_1 correspond to the first k bits of data to be transmitted by the semiconductor device 310, and the l transmitter connectors in the second transmitter connector group Tx_2 correspond to the subsequent/bits of data to be transmitted by the semiconductor device 310. For example, the k transmitter connectors in the first transmitter connector group Tx_1 correspond to bit 0 to bit (k−1), and the/transmitter connectors in the second transmitter connector group Tx_2 correspond to bit k to bit (k+l−1). In other words, the first transmitter connector group Tx_1 comprises k consecutive transmitter connectors, and the second transmitter connector group Tx_2 comprises/consecutive transmitter connectors which are consecutive to the k consecutive transmitter connectors of the first transmitter connector group Tx_1. In some embodiments, k is equal to l. i.e., the first transmitter connector group Tx_1 and the second transmitter connector group Tx_2 includes the same number of transmitter connectors. In at least one embodiment, k is different from 1. In some embodiments, for an X64 connection between the semiconductor device 310 and another semiconductor device, k=l=32. For an X32 connection between the semiconductor device 310 and another semiconductor device, k=l=16. For an X16 connection between the semiconductor device 310 and another semiconductor device, k=l=8. The described numbers of transmitter connector groups and/or numbers of transmitter connectors per transmitter connector group are example. Other configurations are within the scopes of various embodiments.

The plurality of rows of external connectors of the I/O port 300A comprises a first set of rows 321 in which the receiver connectors of the first receiver connector group Rx_1 are arranged, a second set of rows 322 in which the receiver connectors of the second receiver connector group Rx_2 are arranged, a third set of rows 331 in which the transmitter connectors of the first transmitter connector group Tx_1 are arranged, and a fourth set of rows 332 in which the transmitter connectors of the second transmitter connector group Tx_2 are arranged. The first through fourth sets of rows 321, 322, 331, 332 are non-overlapping, i.e., they do not mutually overlap each other.

The plurality of rows of external connectors of the I/O port 300A further comprises one or more rows of external connectors between each pair of adjacent groups among the first receiver connector group Rx_1, second receiver connector group Rx_2, first transmitter connector group Tx_1, second transmitter connector group Tx_2. Specifically, the set of rows 321 including the first receiver connector group Rx_1 is spaced from the set of rows 322 including the second receiver connector group Rx_2 by one or more rows of external connectors schematically designated at 344. The set of rows 321 including the first receiver connector group Rx_1 is spaced from the set of rows 331 including the first transmitter connector group Tx_1 by one or more rows of external connectors schematically designated at 343. The set of rows 331 including the first transmitter connector group Tx_1 is spaced from the set of rows 332 including the second transmitter connector group Tx_2 by one or more rows of external connectors schematically designated at 342.

The plurality of rows of external connectors I/O port 300A further comprises one or more first end rows of external connectors schematically designated at 341, and one or more second end rows of external connectors schematically designated at 345 and adjacent the edge 314 of the semiconductor device 310. The second receiver connector group Rx_2, first receiver connector group Rx_1, first transmitter connector group Tx_1, second transmitter connector group Tx_2 are arranged in the recited order along the column direction C between the one or more first end rows 341 and the one or more second end rows 345.

In some embodiments, the set of rows 321 includes, besides the receiver connectors of the first receiver connector group Rx_1, one or more external connectors configured for one or more functions other than transmission and receipt of main band data. As described herein, such other functions include, but are not limited to, side band data, power, clock, track, valid, or the like. External connectors configured for a function other than transmission and receipt of main band data are referred to herein as other function external connectors. In some embodiments, the set of rows 321 includes one or more other function external connectors in one or more central columns 350C. In at least one embodiment, the one or more central columns 350C correspond to the central columns 251C or the central columns 253C. For example, the set of rows 321 includes, in the one or more central columns 350C, one or more external connectors for clock distribution (hereinafter referred to as clock external connectors).

In some embodiments, the set of rows 322 includes, besides the receiver connectors of the second receiver connector group Rx_2, one or more other function external connectors. In some embodiments, the set of rows 322 includes one or more other function external connectors in one or more central columns 350C. For example, the set of rows 322 includes, in the one or more central columns 350C, one or more external connectors for power distribution (hereinafter referred to as power external connectors). A power external connector configured to be coupled to a power supply voltage is referred to as a power supply external connector. A power external connector configured to be coupled to a ground voltage is referred to as a ground external connector. In at least one embodiment, the power external connectors in the set of rows 322 include only power supply external connector, or only ground external connectors, or a combination of power supply external connectors and ground external connectors.

In some embodiments, the set of rows 331 includes, besides the transmitter connectors of the first transmitter connector group Tx_1, one or more other function external connectors. In some embodiments, the set of rows 331 includes one or more other function external connectors in one or more central columns 350C. For example, the set of rows 331 includes, in the one or more central columns 350C, one or more clock external connectors.

In some embodiments, the set of rows 332 includes, besides the transmitter connectors of the second transmitter connector group Tx_2, one or more other function external connectors. In some embodiments, the set of rows 332 includes one or more other function external connectors in one or more central columns 350C. For example, the set of rows 332 includes, in the one or more central columns 350C, one or more power external connectors.

In some embodiments, the arrangement of clock external connectors and power external connectors in the one or more central columns 350C improves the clock distribution tree which is straightforward, with less depth. In some embodiments, the power external connectors in the one or more central columns 350C include ground external connectors which ensure that clock signals are less affected by power supply transients.

In some embodiments, the rows 341-345 include power external connectors. In at least one embodiment, the one or more rows 341 include at least one full row of power external connectors, and/or the one or more rows 342 include at least one full row of power external connectors, and/or the one or more rows 343 include at least one full row of power external connectors, and/or the one or more rows 344 include at least one full row of power external connectors, and/or the one or more rows 345 include at least one full row of power external connectors. A full row of power external connectors is a row in which every external connector is a power external connector. As a result, in at least one embodiment, a solid power grid is provided, and/or effective shielding for main band data is obtainable as described with respect to FIG. 2D.

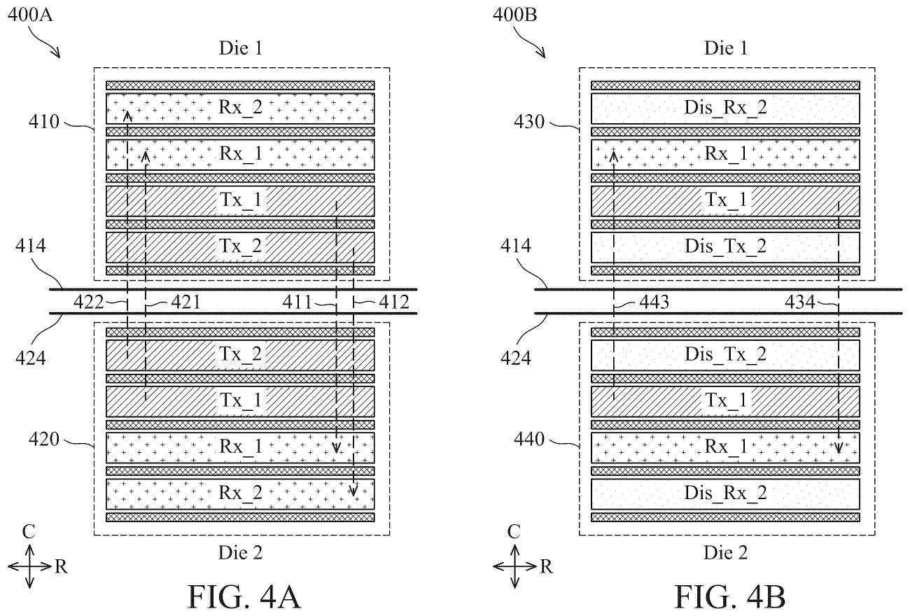

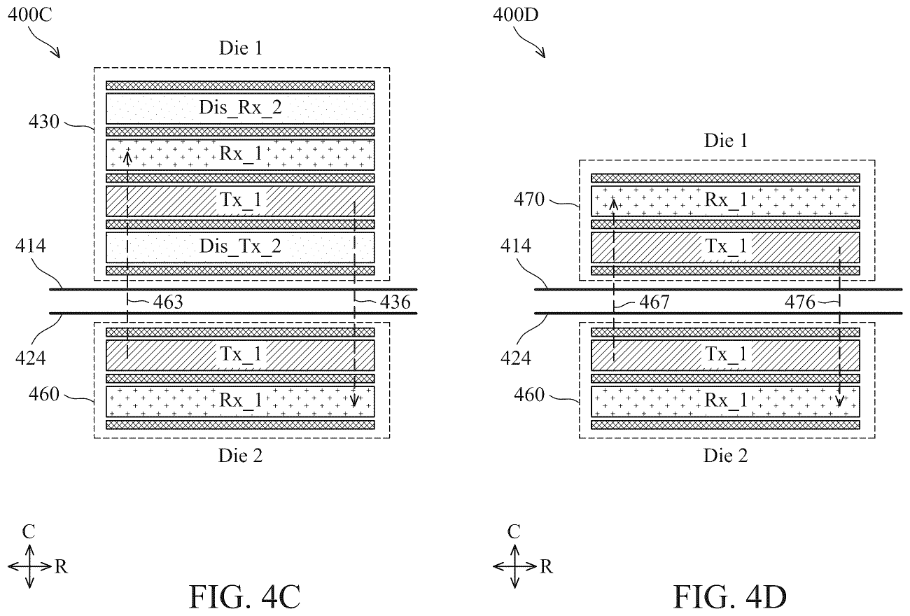

In some embodiments, one or more of the rows 341-345 include, besides power external connectors, one or more other function external connectors. In an example, the one or more of rows 341 include external connectors for side band data. For simplicity, the rows 341-345, and similar rows described herein with respect to FIGS. 3B-3C, 4A-4D, are referred to as power external connector rows, although the power external connector rows may include one or more other function external connectors.

In some embodiments, the I/O port 300A corresponds to the UCIe protocol, and is configured to provide an X64 connection. In this configuration, each of the first receiver connector group Rx_1, second receiver connector group Rx_2, first transmitter connector group Tx_1, second transmitter connector group Tx_2 includes exactly 32 consecutive main band data external connectors.

The described configuration in FIG. 3A where the receiver connectors and transmitter connectors of an I/O port are grouped into two receiver connector groups and two transmitter connector groups is an example. A higher number of groups are within the scopes of various embodiments. For example, in one or more embodiments where an I/O port includes three receiver connector groups and three transmitter connector groups, a third receiver connector group is located above the power external connector rows 345, and a third transmitter connector group is located between the power external connector rows 341 and the edge 314 of the semiconductor device 310. Other configurations are within the scopes of various embodiments.

FIG. 3B is a schematic plan view of an I/O port 300B with a reduced bandwidth compared to the I/O port 300A in FIG. 3A, in accordance with some embodiments. For simplicity, corresponding elements in FIGS. 3A and 3B are designated by the same reference numerals.

The I/O port 300B is the same as the I/O port 300A, except that the receiver connectors in the set of rows 322 and the corresponding transmitter connectors in the set of rows 332 are disabled. In other words, the second receiver connector group Rx_2 and second transmitter connector group Tx_2 of the I/O port 300A are disabled in the I/O port 300B, and correspondingly become a disabled second receiver connector group Dis_Rx_2 and a disabled second transmitter connector group Dis_Tx_2. In some embodiments, the I/O port 300B is used for a connection to another semiconductor device that does not require as a high bandwidth as that provided by the I/O port 300A. In an example, where k is equal to l, the bandwidth of the I/O port 300B is half of the bandwidth of the I/O port 300A.

In at least one embodiment, the disabled second receiver connector group Dis_Rx_2 and/or the disabled second transmitter connector group Dis_Tx_2 still include the corresponding receiver connectors and/or transmitter connectors. However, corresponding main band data lanes are not formed in the interconnect structure. As a result, the disabled receiver connectors and transmitter connectors are not coupled to the other semiconductor device. In another example, disabled external connectors are not manufactured. In at least one embodiment, by not having to form unnecessary external connectors or corresponding lanes in an interconnect structure, the manufacturing cost and/or manufacturing time of an IC device including dies coupled by the interconnect structure are reduced.

In at least one embodiment, the disabled second receiver connector group Dis_Rx_2 and/or the disabled second transmitter connector group Dis_Tx_2 still include the corresponding receiver connectors and/or transmitter connectors which are still coupled by corresponding main band data lanes in the interconnect structure to the other semiconductor device. However, receiver circuitry and/or transmitter circuitry configured to drive the receiver connectors and/or transmitter connectors are disabled, or configured or controlled to operate in a sleep or low power mode. As a result, main band data are not received and/or transmitted by the disabled second receiver connector group Dis_Rx_2 and/or disabled second transmitter connector group Dis_Tx_2. In at least one embodiment, by not operating unnecessary main band data lanes, power consumption is reduced.

In some embodiments, an arrangement of external connectors, also referred to herein as a bump map, of the I/O port 300B is obtainable from the bump map of the I/O port 300A, simply by marking the second receiver connector group Rx_2 and second transmitter connector group Tx_2 of the I/O port 300A as being disabled. In at least one embodiment, such marking is performed by one or more processors, e.g., of an EDA system, as described herein. In one or more embodiments, no further modification or redesign or relocation of external connectors is required in the so-obtained bump map. As a result, scalability of I/O ports is improved in one or more embodiments. The improved scalability is achievable in one or more embodiments, because the receiver connectors and transmitter connectors in the I/O port 300A are grouped into multiple groups arranged in non-overlapping sets of rows. Accordingly, it is possible and simple to disable a receiver or transmitter connector group by disabling the rows including the receiver or transmitter connectors of the group to be disabled. In at least one embodiment, this is an improvement over the other approaches in which receiver connectors and transmitter connectors are not grouped, and therefore, it is difficult to disable unnecessary receiver connectors and/or transmitter connectors, i.e., it is difficult to scale one bump map to obtain another bump map.

In some embodiments, the I/O port 300B corresponds to the UCIe protocol, and is configured to provide an X32 connection. In this configuration, each of the first receiver connector group Rx_1 and first transmitter connector group Tx_1 in the I/O port 300B includes exactly 32 consecutive main band data external connectors.

FIG. 3C is a schematic plan view showing generation of a bump map for an I/O port 300C with reduced bandwidth from a bump map of the I/O port 300A, in accordance with some embodiments. For simplicity, corresponding elements in FIGS. 3A and 3C are designated by the same reference numerals.

To generate the bump map for the I/O port 300C, the set of rows 321 including the first receiver connector group Rx_1 and the set of rows 331 including the first transmitter connector group Tx_1 of the I/O port 300A are replicated in the bump map of the I/O port 300C, as schematically indicated by arrows 362, 363. The second receiver connector group Rx_2 and second transmitter connector group Tx_2 of the I/O port 300A are not replicated in the I/O port 300C. As a result, the I/O port 300C has a reduced bandwidth compared to the I/O port 300A. In one or more embodiments, modifications and/or relocations of receiver connectors and transmitter connectors for main band data are not required when the bump map for the I/O port 300C is generated from the bump map of the I/O port 300A. In at least one embodiment, the described replication of rows of external connectors is performed by one or more processors, e.g., of an EDA system, as described herein.

The I/O port 300C further comprises power external connector rows 381, 383, 385 correspondingly similarly to the power external connector rows 341, 343, 345 of the I/O port 300A. In some embodiments, the generation of the bump map for the I/O port 300C comprises replications of one or more of the power external connector rows 341, 343, 345 correspondingly as power external connector rows 381, 383, 385 in the bump map of the I/O port 300C, with further modifications or relocations of one or more other function external connectors in the power external connector rows 381, 383, 385 to ensure proper functionality of the I/O port 300C with the reduced bandwidth.

The I/O port 300C has the same bandwidth as the I/O port 300B. In some embodiments, the I/O port 300C corresponds to the UCIe protocol, and is configured to provide an X32 connection. In this configuration, each of the first receiver connector group Rx_1 and first transmitter connector group Tx_1 in the I/O port 300C includes exactly 32 consecutive main band data external connectors.

In at least one embodiment, one or more advantages described herein with respect to the I/O port 300A and/or I/O port 300B are achievable by the I/O port 300C. Further, compared to the I/O port 300A and I/O port 300B, the I/O port 300C has a smaller size or form factor, which further lowers the manufacturing cost and/or manufacturing time, in one or more embodiments.

FIG. 4A is a schematic plan view of an IC device 400A, in accordance with some embodiments.

The IC device 400A comprises two semiconductor devices or dies, i.e., Die 1 and Die 2, coupled to each other by an interconnect structure. Die 1 has an I/O port 410 adjacent an edge 414 of Die 1. Die 2 has an I/O port 420 adjacent an edge 424 facing the edge 414 of Die 1. In some embodiments, Die 1, I/O port 410, edge 414, Die 2, I/O port 420, edge 424 correspond to die 110, I/O port 112, edge 114, die 120, I/O port 122, edge 124 described with respect to FIG. 1. In the example configuration in FIG. 4A, each of the I/O port 410 and I/O port 420 has the configuration of the I/O port 300A.

The corresponding external connectors in the I/O port 410 and I/O port 420 are coupled to each other by corresponding lanes in the interconnect structure. For simplicity, the interconnect structure is not fully illustrated, and is schematically represented by main band data lanes 411, 412, 421, 422. The interconnect structure includes further lanes for one or more other functions, such as side band, power, clock, track, valid, or the like. The lanes for such other functions are omitted in FIG. 4A for simplicity.

Specifically, the transmitter connectors in the first transmitter connector group Tx_1 of Die 1 are correspondingly coupled, by main band data lanes 411, to the receiver connectors in the first receiver connector group Rx_1 of Die 2. The transmitter connectors in the second transmitter connector group Tx_2 of Die 1 are correspondingly coupled, by main band data lanes 412, to the receiver connectors in the second receiver connector group Rx_2 of Die 2. The transmitter connectors in the first transmitter connector group Tx_1 of Die 2 are correspondingly coupled, by main band data lanes 421, to the receiver connectors in the first receiver connector group Rx_1 of Die 1. The transmitter connectors in the second transmitter connector group Tx_2 of Die 2 are correspondingly coupled, by main band data lanes 422, to the receiver connectors in the second receiver connector group Rx_2 of Die 1. In some embodiments, the lengths of the main band data lanes 411, 412, 421, 422 along the column direction Care the same, or substantially the same, to advantageously ensure a uniform signal delay across all main band data lanes, as described with respect to FIG. 2C. In at least one embodiment, one or more advantages described herein are achievable by the IC device 400A.

FIG. 4B is a schematic plan view of an IC device 400B, in accordance with some embodiments. For simplicity, corresponding elements in FIGS. 4A and 4B are designated by the same reference numerals.

In the example configuration in FIG. 4B, Die 1 has an I/O port 430, Die 2 has a corresponding I/O port 440, and each of the I/O port 430 and I/O port 440 has the configuration of the I/O port 300B. The transmitter connectors in the first transmitter connector group Tx_1 of Die 1 are correspondingly coupled, by main band data lanes 434 formed in an interconnect structure, to the receiver connectors in the first receiver connector group Rx_1 of Die 2. The transmitter connectors in the first transmitter connector group Tx_1 of Die 2 are correspondingly coupled, by main band data lanes 443 formed in the interconnect structure, to the receiver connectors in the first receiver connector group Rx_1 of Die 1. The receiver connectors and transmitter connectors in the disabled second transmitter connector groups Dis_Tx_2 and disabled second receiver connector groups Dis_Rx_2 of Die 1 and Die 2 are not coupled to each other. In some embodiments, the lengths of the main band data lanes 434, 443 along the column direction C are the same, or substantially the same. In at least one embodiment, one or more advantages described herein are achievable by the IC device 400B.

FIG. 4C is a schematic plan view of an IC device 400C, in accordance with some embodiments. For simplicity, corresponding elements in FIGS. 4B and 4C are designated by the same reference numerals.

In the example configuration in FIG. 4C, Die 1 has the I/O port 430 with the configuration of the I/O port 300B, and Die 2 has a corresponding I/O port 460 with the configuration of the I/O port 300C. The transmitter connectors in the first transmitter connector group Tx_1 of Die 1 are correspondingly coupled, by main band data lanes 436 formed in an interconnect structure, to the receiver connectors in the first receiver connector group Rx_1 of Die 2. The transmitter connectors in the first transmitter connector group Tx_1 of Die 2 are correspondingly coupled, by main band data lanes 463 formed in the interconnect structure, to the receiver connectors in the first receiver connector group Rx_1 of Die 1. The receiver connectors and transmitter connectors in the disabled second transmitter connector groups Dis_Tx_2 and disabled second receiver connector groups Dis_Rx_2 of Die 1 are not coupled to Die 2. In some embodiments, the lengths of the main band data lanes 436, 463 along the column direction C are the same, or substantially the same. In at least one embodiment, one or more advantages described herein are achievable by the IC device 400C.

FIG. 4D is a schematic plan view of an IC device 400D, in accordance with some embodiments. For simplicity, corresponding elements in FIGS. 4C and 4D are designated by the same reference numerals.

In the example configuration in FIG. 4D, Die 1 has an I/O port 470 with the configuration of the I/O port 300C, and Die 2 has the corresponding I/O port 460 also with the configuration of the I/O port 300C. The transmitter connectors in the first transmitter connector group Tx_1 of Die 1 are correspondingly coupled, by main band data lanes 476 formed in an interconnect structure, to the receiver connectors in the first receiver connector group Rx_1 of Die 2. The transmitter connectors in the first transmitter connector group Tx_1 of Die 2 are correspondingly coupled, by main band data lanes 467 formed in the interconnect structure, to the receiver connectors in the first receiver connector group Rx_1 of Die 1. In some embodiments, the lengths of the main band data lanes 476, 467 along the column direction C are the same, or substantially the same. In at least one embodiment, one or more advantages described herein are achievable by the IC device 400C.

As described herein with respect to one or more of FIGS. 3A-3C and 4A-4D, it is possible and/or simple in one or more embodiments to scall an I/O port to use only a portion, e.g., a half, of its designed bandwidth to interface with a corresponding I/O port of a smaller bandwidth on another die. In some embodiments, the described scalability is applicable to obtain I/O ports of various bandwidths, and/or form factors.

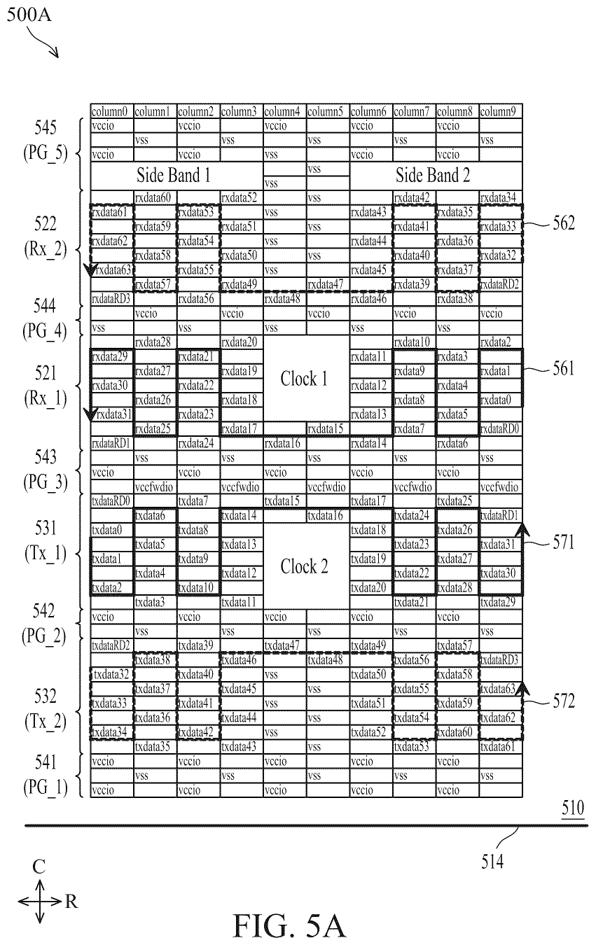

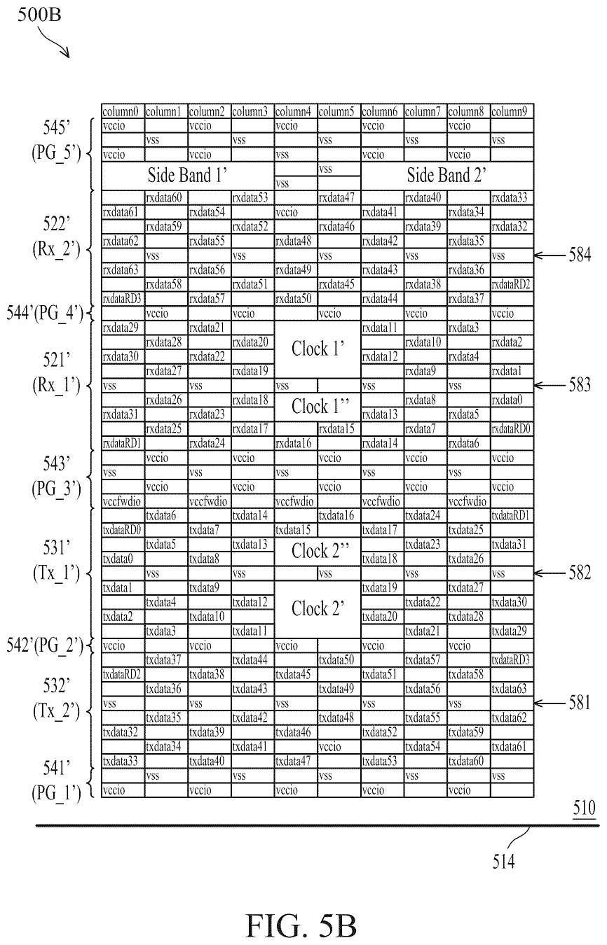

FIG. 5A is a schematic view of a bump map 500A for an I/O port of a semiconductor device, in accordance with some embodiments. In some embodiments, the bump map 500A is applicable to the I/O port 300A.

The bump map 500A comprises a set of external connectors, or bumps, arranged in a plurality of columns and rows. The columns of the bump map 500A are numbered as column 0 to column 9. For simplicity, the rows of the bump map 500A are not numbered. The external connectors of the bump map 500A are arranged in a staggering manner, as described with respect to FIG. 2B.

The bump map 500A comprises a first receiver connector group Rx_1 including consecutive receiver connectors rxdata0 to rxdata31 arranged in a pattern or sequence 561 in a first set of rows 521. The bump map 500A further comprises a second receiver connector group Rx_2 including consecutive receiver connectors rxdata32 to rxdata63 arranged in a pattern or sequence 562 in a second set of rows 522. The receiver connectors rxdata32 to rxdata63 are subsequent to the receiver connectors rxdata0 to rxdata31 in the first receiver connector group Rx_1. The bump map 500A further comprises a first transmitter connector group Tx_1 including consecutive transmitter connectors txdata0 to txdata31 arranged in a pattern or sequence 571 in a third set of rows 531. The bump map 500A further comprises a second transmitter connector group Tx_2 including consecutive transmitter connectors txdata32 to txdata63 arranged in a pattern or sequence 572 in a fourth set of rows 532. The transmitter connectors txdata32 to txdata63 are subsequent to the transmitter connectors txdata0 to txdata31 in the first transmitter connector group Tx_1.

The pattern 571 in the first transmitter connector group Tx_1 corresponds to the pattern 561 in the first receiver connector group Rx_1 rotated by 180 degrees around a point. The pattern 572 in the second transmitter connector group Tx_2 corresponds to the pattern 562 in the second transmitter connector group Tx_2 rotated by 180 degrees around a point. Accordingly, in some embodiments, when an I/O port having the bump map 500A is coupled to another, corresponding I/O port as described with respect to FIG. 4A, the corresponding main band data lanes all have the same length.

Besides the corresponding receiver connectors and transmitter connectors, the set of rows 521 and the set of rows 531 further comprise, in central column 4 and column 5, clock external connectors in corresponding regions schematically designated as Clock 1, Clock 2. In some embodiments, one or more of the regions Clock 1, Clock 2 includes other function external connectors, such as external connectors for valid and/or tracking signals. As described herein, in one or more embodiments, the arrangement of clock external connectors in the central columns provides one or more advantages, such as clean clock distribution.

The bump map 500A further comprises power external connector rows 541-545 corresponding to power external connector rows 341-345 described with respect to FIG. 3A. Power external connectors in the power external connector rows 541-545 include ground external connectors vss, and power supply external connectors vccio and vccfwdio. In some embodiments, vccio and vccfwdio correspond to different power supply voltages. Each of the power external connector rows 541-545 includes at least one row full of power external connectors of the same voltage, e.g., at least one full row of ground external connectors vss, at least one full row of power supply external connectors vccio, and/or at least one full row of power supply external connectors vccfwdio. As a result and as described herein, a shielding effect against signal crosstalk is obtainable in one or more embodiments.

Besides the corresponding receiver connectors and transmitter connectors, the set of rows 522 and the set of rows 532 further comprise, in central column 4 and column 5, ground external connectors vss. As a result and as described herein, it is possible in one or more embodiments to shield the clock distribution paths from power supply transients. The power external connector rows 545 further comprise external connector for side band data in corresponding regions schematically designated as Side Band 1, Side Band 2. In some embodiments, the bump map 500A corresponds to the UCIe protocol and an X64 die-to-die connection.

In some embodiments, to obtain a bump map for an I/O port with a reduced bandwidth, e.g., for an X32 die-to-die connection, it is sufficient to disable the set of rows 522 including the second receiver connector group Rx_2 and the set of rows 532 including the second transmitter connector group Tx_2, as described with respect to FIG. 3B.

In some embodiments, to generate a bump map for an I/O port with a reduced bandwidth, e.g., for an X32 die-to-die connection, the set of rows 521 including the first receiver connector group Rx_1 and the set of rows 531 including the first transmitter connector group Tx_1 are replicated in the bump map to be generated, as described with respect to FIG. 3C. In at least one embodiment, one or more advantages described herein are achievable by an I/O port having the bump map 500A. Further, main band data lanes are uniformly distributed in at least the columns other than the central column 4 and column 5. As a result and as described with respect to FIG. 2C, the number of metal layers required in the interconnect structure is optimized and/or minimized.

FIG. 5B is a schematic view of a bump map 500B for an I/O port of a semiconductor device, in accordance with some embodiments. For simplicity, components in the bump map 500B having corresponding components in the bump map 500A are designated by the reference numerals of the bump map 500A but with the prime symbol and/or the double prime symbol.

The bump map 500B is different from the bump map 500A in that a full row 581, 582, 583, 584 of power external connectors is correspondingly included in the set of rows 532′, 542′, 521′, 522′ of the second transmitter connector group Tx_2′, first transmitter connector group Tx_1′, first receiver connector group Rx_1′, second receiver connector group Rx_2′. As a result, in one or more embodiments the shielding effect against crosstalk is further enhanced.

As described herein, some embodiments provide an arrangement of external connectors, or a bump map, which is suitable for a die-to-die connection through an interconnect structure. In at least one embodiment, the bump map is scalable for various bandwidths and/or form factors. In some embodiments, scaling is simple, without requiring redesigns and/or relocations of at least the main band data bumps. As a result, it is possible in one or more embodiments to perform chip integration using lower cost package technology where appropriate. In at least one embodiment, it is possible to achieve one or more advantages including, but not limited to, compliance with advanced protocols such as the UCIe protocol, robust power delivery, clean clock distribution, improved routing and signal integrity, enhanced shielding effect, or the like.

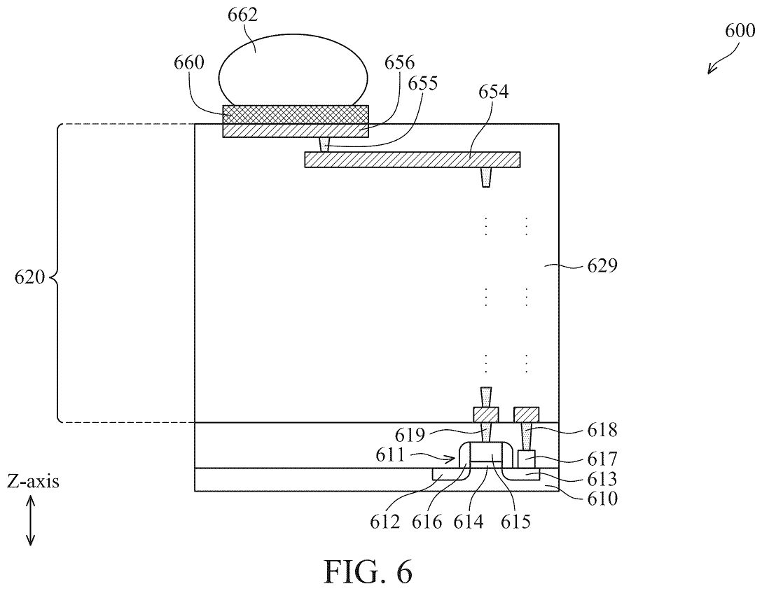

FIG. 6 is a schematic cross-sectional view of a portion of a semiconductor device 600, in accordance with some embodiments. In some embodiments, the semiconductor device 600 corresponds to any semiconductor device or die described with respect to one or more of FIGS. 1, 3A-3C, 4A-4D.

The semiconductor device 600 comprises a substrate 610 over which functional circuitry of the semiconductor device 600 is formed. The functional circuitry of the semiconductor device 600 comprises a plurality of circuit elements electrically coupled together to perform one or more operations or functionality. In FIG. 6, a transistor 611 is illustrated as an example circuit element of the functional circuitry of the semiconductor device 600. The transistor 611 comprises source/drain regions 612, 613 which are P-doped or N-doped regions formed by P-type or N-type dopants added to the substrate 610. In some embodiments, P-doped or N-doped regions are formed in N-wells or P-wells. In some embodiments, isolation structures are formed between adjacent P well/P-doped regions and N well/N-doped regions. For simplicity, isolation structures are omitted from FIG. 6. The transistor 611 further comprises a gate stack including a gate dielectric layer 614, and a gate electrode 615. In at least one embodiment, the gate dielectric layer comprises multiple gate dielectric layers. Example materials of the gate dielectric layer or layers include HfO2, ZrO2, or the like. Example materials of the gate electrode 615 include polysilicon, metal, or the like. Spacers 616 are formed on sidewalls of the gate stack. Example materials of the spacers 616 include, but are not limited to, silicon nitride, oxynitride, silicon carbide, or the like. Contact structures, sometimes referred to as metal-to-device (MD) structures, are formed over the source/drain regions of the transistor 611 to define an electrical connection from the transistor 611 to other circuit elements. In FIG. 6, an MD contact structure 617 is illustrated as being over and electrically coupled to the source/drain region 613. An MD contact structure over and electrically coupled to the source/drain region 612 is omitted for simplicity. A via 618 is over and in electrical contact with the MD contact structure 617. The via 618 is sometimes referred to as a via-to-device (VD). A via 619 is over and in electrical contact with the gate electrode 615. The via 619 is sometimes referred to as via-to-gate (VG). An example material of the VD and VG vias includes metal.

The semiconductor device 600 further comprises a redistribution layer 620 over the substrate 610 along a thickness direction of the substrate 610, which is indicated as Z-axis in FIG. 6. The redistribution layer 620 comprises a plurality of metal layers and via layers sequentially and alternatingly arranged over the VD, VG vias along the Z-axis. The redistribution layer 620 further comprises an interlayer dielectric (ILD) 629 in which the metal layers and via layers are embedded. In the example configuration in FIG. 6, the functional circuitry represented by the transistor 611 is coupled through various metal layers and via layers to a conductive pattern 654 adjacent the top of the redistribution layer 620, then to a via 655, and then to a contact pad 656. Example materials of the contact pad 656 include, but are not limited to, aluminum, copper, silver, gold, tungsten, nickel, alloys thereof, multi-layers thereof, or the like.

A under-bump-metallurgy (UBM) structure 660 is over and in electrical contact with the contact pad 656. The UBM structure 660 is configured to receive a bump 662 for physically and electrically coupling the semiconductor device 600 to another device, e.g., an interconnect structure, interposer, or the like. Example materials of the UBM structure 660 include, but are not limited to, one or more layers of copper, tantalum, titanium, nickel, copper, alloys thereof, or the like. Example materials of the bump 662 include, but are not limited to, one or more layers of solder, tin, lead, copper, gold, silver, zinc, bismuth, magnesium, antimony, indium, alloys thereof, or the like. In some embodiments, the semiconductor device 600 further comprises a passivation layer (not shown) in which the contact pad 656 and/or the UBM structure 660 is/are partially embedded. Example materials of the passivation layer include, but are not limited to, silicon nitride (SiN), silicon dioxide (SiO₂), silicon oxynitride (SiON), un-doped silicate glass (USG), polymer, multi-layers thereof, or the like. Example polymers include, but are not limited to, epoxy, polyimide, benzocyclobutene (BCB), polybenzoxazole (PBO), multi-layers thereof, or the like.

In some embodiments, the semiconductor device 600 comprises a plurality of bumps 662 arranged in accordance with a bump map of an I/O port as described herein.

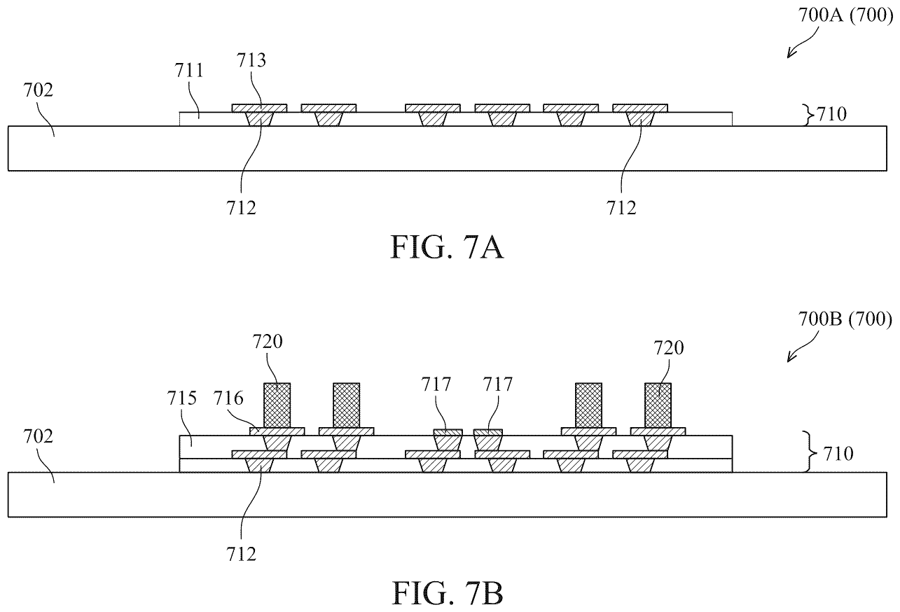

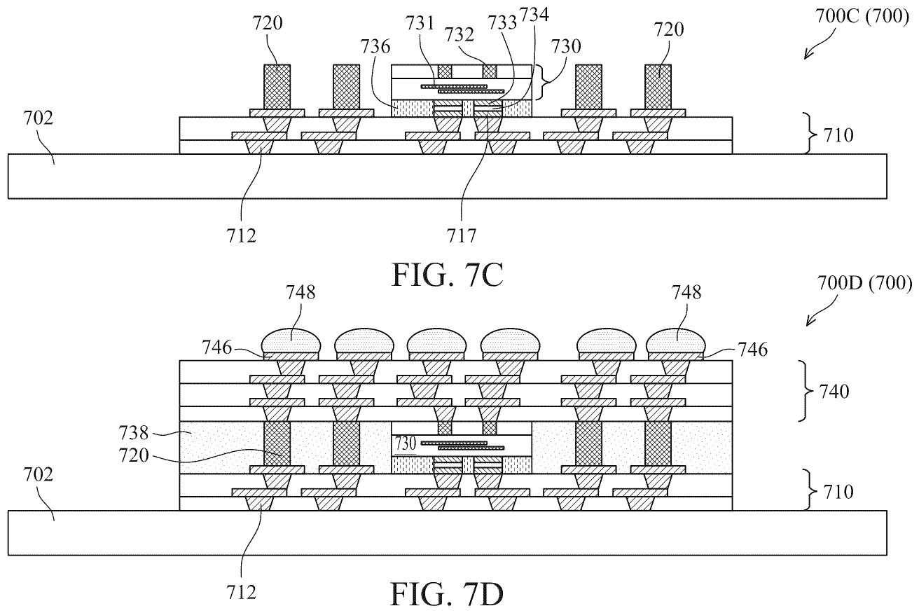

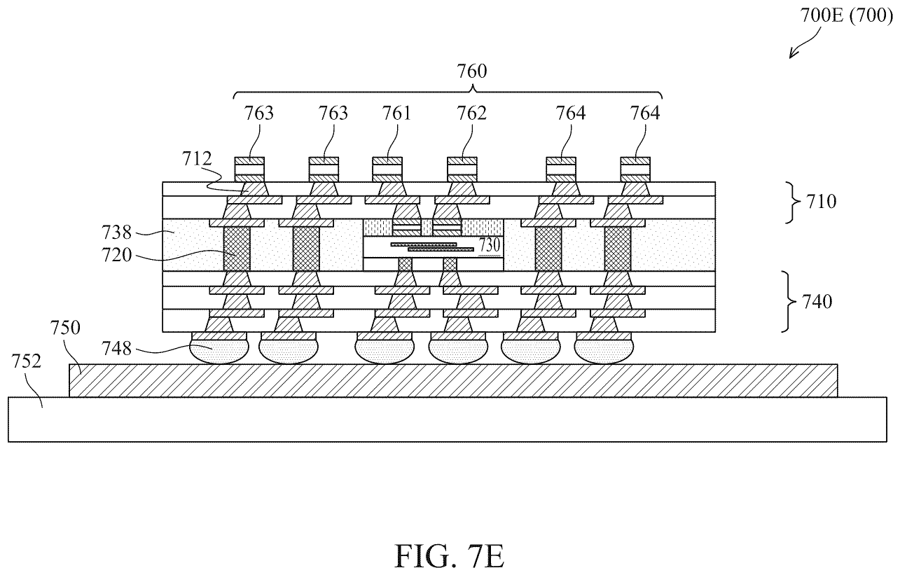

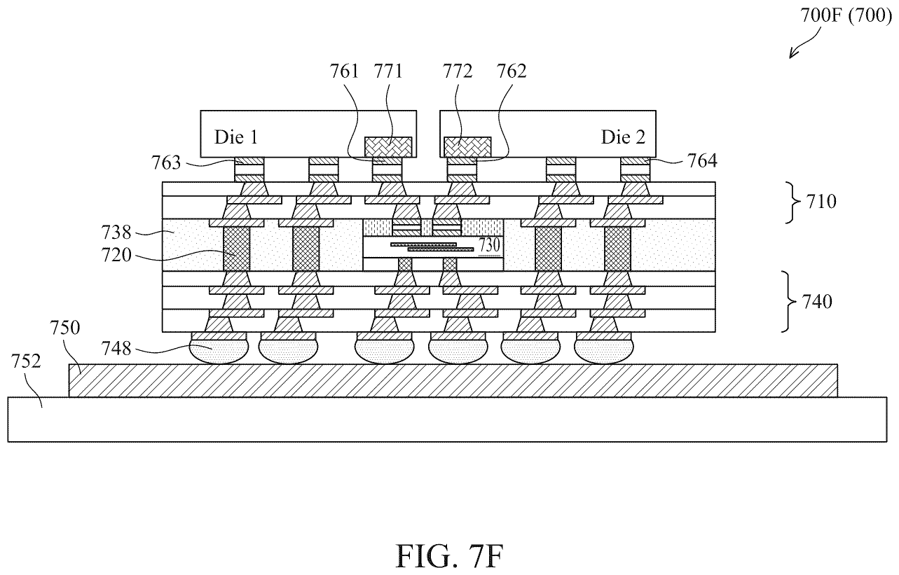

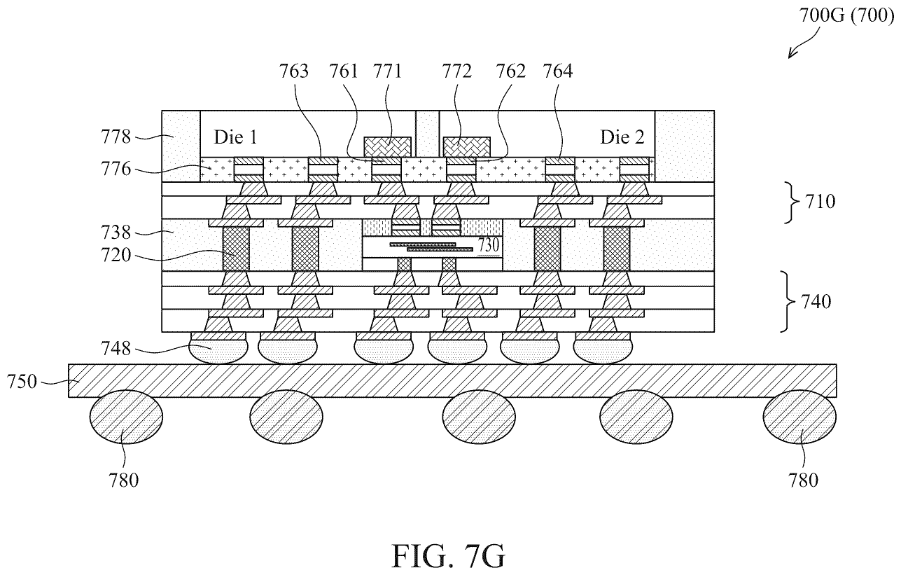

FIGS. 7A-7G are schematic cross-sectional views of an IC device 700 at various stages in a manufacturing process, in accordance with some embodiments. In some embodiments, the IC device 700 corresponds to one or more of the IC devices described with respect to FIGS. 1, 4A-4D.

In FIG. 7A, a first redistribution layer (RDL) 710 is formed over a first carrier substrate 702. For example, a release layer (not shown) is deposited over the first carrier substrate 702. A dielectric layer 711 is deposited over the release layer, then patterned to form via openings. A conductive material, e.g., a metal, is filled into the openings and patterned, to form conductive vias 712 and conductive traces 713. As a result, a structure 700A is obtained.

In FIG. 7B, additional dielectric layers and conductive materials are deposited, and patterned as described with respect to FIG. 7A to build further conductive vias and traces of the first RDL 710. The finished first RDL 710 comprises a top dielectric layer 715 with conductive pads 716, 717 thereon. Through vias 720 are formed over the conductive pads 716, e.g., by an electroplating process. As a result, a structure 700B is obtained.

In FIG. 7C, an interconnect structure 730, e.g., an LSI or a silicon bridge, is manufactured separately and attached to the conductive pads 717. In some embodiments, the interconnect structure 730 comprises a fine-pitch RDL 731 formed, e.g., by a dual damascene process, in a semiconductor substrate (not numbered). In some embodiments, the interconnect structure 730 corresponds to one of more of the interconnect structures described with respect to FIGS. 1-4D, and the fine-pitch RDL 731 includes conductive traces, or lanes, for coupling the I/O ports of dies as described herein. The interconnect structure 730 further comprises through interconnect vias 732 over and coupled to the fine-pitch RDL 731. The interconnect structure 730 further comprises connectors 733, e.g., micro bumps, under and coupled to the fine-pitch RDL 731. The connectors 733 are attached to the corresponding conductive pads 717 by a solder material 734, thereby attaching the interconnect structure 730 to the first redistribution layer 710. A underfill material 736 is deposited in between the interconnect structure 730 and the first redistribution layer 710. As a result, a structure 700C is obtained.

In FIG. 7D, the interconnect structure 730 and the through vias 720 are encapsulated in a first encapsulant 738. A second RDL 740 is built over the first encapsulant 738 in a manner similar to that described with respect to the first RDL 710. The finished second RDL 740 comprises top conductive pads 746 which are coupled through a plurality of metal layers and via layers of the second RDL 740 to the through vias 720 and the interconnect structure 730. Solder bumps 748, e.g., C4 bumps, are formed over the conductive pads 746. As a result, a structure 700D is obtained.

In FIG. 7E, an interposer 750 is attached to the solder bumps 748. The first carrier substrate 702 is detached, the remaining structure is flipped over, and the interposer 750 is releasably attached to a second carrier substrate 752. As a result of the structure being flipper over, the vias 712 of the first RDL 710 are exposed. External connectors 760 are formed over the exposed vias 712. In some embodiments, conductive traces (not shown) are formed over the exposed vias 712 and external connectors 760 are then formed over the conductive traces. The external connectors 760 comprise a first set of external connectors 761 to be attached to an I/O port of a first die, and a second set of external connectors 762 to be attached to an I/O port of a second die. In some embodiments, the first set of external connectors 761 and the second set of external connectors 762 correspond to one or more bump maps described herein. The external connectors 760 further comprise external connectors 763, 764. As a result, a structure 700E is obtained.

In FIG. 7F, a first die, i.e., Die 1 having an I/O port 771, is bonded to the first set of external connectors 761 and the external connectors 763. External connectors of the I/O port 771 are correspondingly bonded to the first set of external connectors 761. A second die, i.e., Die 2 having an I/O port 772, is bonded to the second set of external connectors 762 and the external connectors 764. External connectors of the I/O port 772 are correspondingly bonded to the second set of external connectors 762. In some embodiments, Die 1 and Die 2 are separately manufactured by a process described with respect to FIG. 6. Die 1 and Die 2 are then coupled by the interconnect structure 730 in a manner described with respect to one or more of FIGS. 1, 2C-2D, 4A-4D. As a result, a structure 700F is obtained.

In FIG. 7G, a underfill material 776 is deposited in between the first RDL 710 and the dies. The dies are then encapsulated in a second encapsulant 778. The second carrier substrate 752 is detached to expose a surface of the interposer 750, and solder bumps 780 are formed over the exposed surface of the interposer 750. As a result, a structure 700G is obtained.

The described process is an example. Other configurations and/or processes are within the scopes of various embodiments. For example, the interconnect structure 730, e.g., a silicon bridge, having fine-pitch RDL 731 provides improved routing ability and is suitable for high speed, high bandwidth applications or IC devices. Such a silicon bridge is, however, relatively expensive to manufacture. For low cost applications or IC devices which do not require high speed or high bandwidth, other interconnect structure configurations, such as RDLs and/or interposers, are used instead for coupling dies. The described scalability in accordance with some embodiments provides flexibility in design and manufacture of IC devices or packages to meet different considerations.

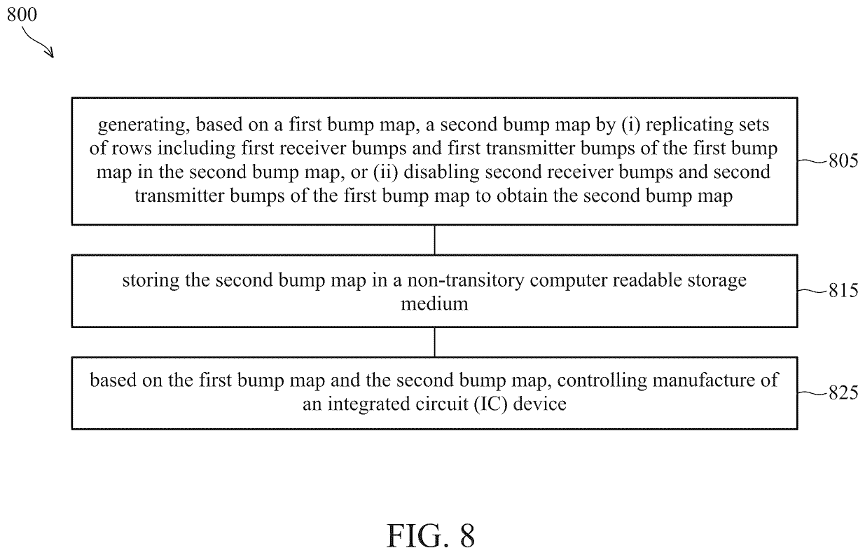

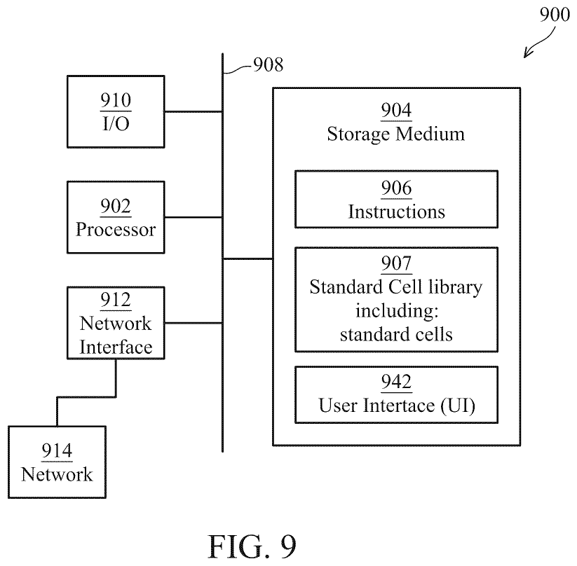

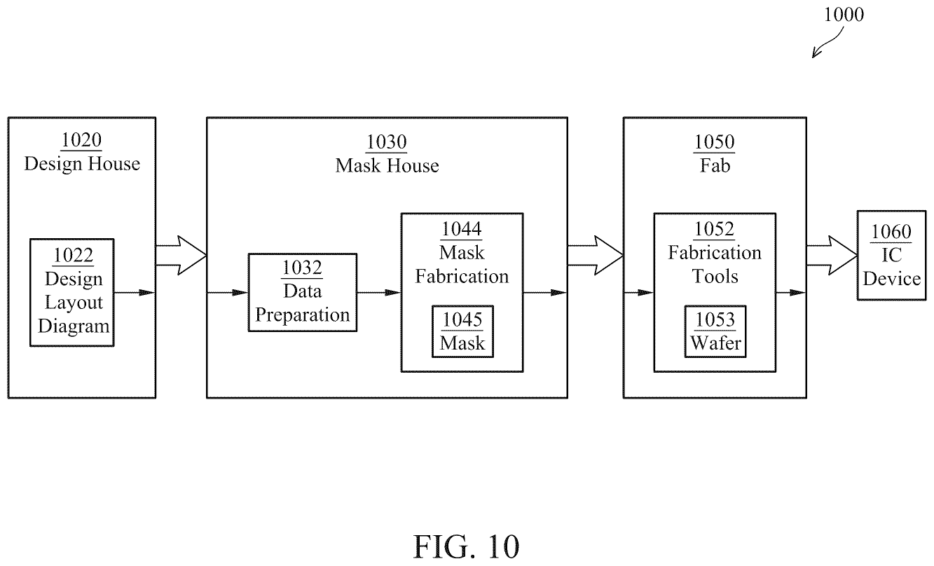

FIG. 8 is a flowchart of a method 800, in accordance with some embodiments. In some embodiments, the method 800 is performed at least in part by one or more processors. In an example, the method 800 is implementable at least in part by an electronic design automation (EDA) system 900 (FIG. 9, discussed below) and/or an integrated circuit (IC) manufacturing system 1000 (FIG. 10, discussed below), in accordance with some embodiments.

At operation 805, based on a first bump map, a second bump map is generated. In some embodiments, sets of rows including first receiver bumps and first transmitter bumps of the first bump map are replicated in the second bump map. For example, as described with respect to FIG. 3C, a set of rows 321 including first receiver bumps of the first receiver connector group Rx_1 and a set of rows 331 including first transmitter bumps of the first transmitter connector group Tx_1 of the first bump map of the I/O port 300A are replicated in a second bump map of the I/O port 300C. In at least one embodiment, such replication is performed by one or more processors, e.g., of an EDA system, as described herein.

In some embodiments, second receiver bumps and second transmitter bumps of the first bump map are disabled to obtain the second bump map. For example, as described with respect to FIG. 3B, receiver bumps in the second receiver connector group Rx_2 and transmitter bumps in the second transmitter connector group Tx_2 of the first bump map of the I/O port 300A are disabled, to obtain a second bump map for the I/O port 300B. In at least one embodiment, the receiver bumps and transmitter bumps are marked as disabled by one or more processors of, e.g., an EDA system, as described herein. In an example, when the receiver bumps and transmitter bumps are marked as disabled, routing for the disabled receiver bumps and transmitter bumps is not performed by the EDA system, and corresponding lanes are not formed by the IC manufacturing system. Other configurations for disabling unnecessary receiver bumps and transmitter bumps are within the scopes of various embodiments.

At operation 815, the generated second bump map is stored in a non-transitory computer readable storage medium. In some embodiments, the first bump map is also stored in a non-transitory computer readable storage medium.

At operation 825, based on the first bump map and the second bump map, an integrated circuit (IC) device is manufactured. For example, the first and second bump maps are retrieved and used by an EDA system for designing I/O ports of dies to be coupled together, and/or for designing an interconnect structure configured to couple the dies together. Based on the designs of the dies and/or the interconnect structure, the dies and interconnect structure are manufactured and coupled together, e.g., by an IC manufacturing system, to obtain an IC device, e.g., as described with respect to FIGS. 7A-7G. In at least one embodiment, one or more advantages described herein are achievable by a bump map and/or an IC device obtained by performing the method 800.

The described methods include example operations, but they are not necessarily required to be performed in the order shown. Operations may be added, replaced, changed order, and/or eliminated as appropriate, in accordance with the spirit and scope of embodiments of the disclosure. Embodiments that combine different features and/or different embodiments are within the scope of the disclosure and will be apparent to those of ordinary skill in the art after reviewing this disclosure.

In some embodiments, at least one method(s) discussed above is performed in whole or in part by at least one EDA system. In some embodiments, an EDA system is usable as part of a design house of an IC manufacturing system discussed below.

FIG. 9 is a block diagram of an electronic design automation (EDA) system 900 in accordance with some embodiments.

In some embodiments, EDA system 900 includes an APR system. Methods described herein of designing layout diagrams represent wire routing arrangements, in accordance with one or more embodiments, are implementable, for example, using EDA system 900, in accordance with some embodiments.

In some embodiments, EDA system 900 is a general purpose computing device including a hardware processor 902 and a non-transitory, computer-readable storage medium 904. Storage medium 904, amongst other things, is encoded with, i.e., stores, computer program code 906, i.e., a set of executable instructions. Execution of instructions 906 by hardware processor 902 represents (at least in part) an EDA tool which implements a portion or all of the methods described herein in accordance with one or more embodiments (hereinafter, the noted processes and/or methods).

Processor 902 is electrically coupled to computer-readable storage medium 904 via a bus 908. Processor 902 is also electrically coupled to an I/O interface 910 by bus 908. A network interface 912 is also electrically connected to processor 902 via bus 908. Network interface 912 is connected to a network 914, so that processor 902 and computer-readable storage medium 904 are capable of connecting to external elements via network 914. Processor 902 is configured to execute computer program code 906 encoded in computer-readable storage medium 904 in order to cause system 900 to be usable for performing a portion or all of the noted processes and/or methods. In one or more embodiments, processor 902 is a central processing unit (CPU), a multi-processor, a distributed processing system, an application specific integrated circuit (ASIC), and/or a suitable processing unit.

In one or more embodiments, computer-readable storage medium 904 is an electronic, magnetic, optical, electromagnetic, infrared, and/or a semiconductor system (or apparatus or device). For example, computer-readable storage medium 904 includes a semiconductor or solid-state memory, a magnetic tape, a removable computer diskette, a random access memory (RAM), a read-only memory (ROM), a rigid magnetic disk, and/or an optical disk. In one or more embodiments using optical disks, computer-readable storage medium 904 includes a compact disk-read only memory (CD-ROM), a compact disk-read/write (CD-R/W), and/or a digital video disc (DVD).

In one or more embodiments, storage medium 904 stores computer program code 906 configured to cause system 900 (where such execution represents (at least in part) the EDA tool) to be usable for performing a portion or all of the noted processes and/or methods. In one or more embodiments, storage medium 904 also stores information which facilitates performing a portion or all of the noted processes and/or methods. In one or more embodiments, storage medium 904 stores library 907 of standard cells including such standard cells as disclosed herein.

EDA system 900 includes I/O interface 910. I/O interface 910 is coupled to external circuitry. In one or more embodiments, I/O interface 910 includes a keyboard, keypad, mouse, trackball, trackpad, touchscreen, and/or cursor direction keys for communicating information and commands to processor 902.

EDA system 900 also includes network interface 912 coupled to processor 902. Network interface 912 allows system 900 to communicate with network 914, to which one or more other computer systems are connected. Network interface 912 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 900.

System 900 is configured to receive information through I/O interface 910. The information received through I/O interface 910 includes one or more of instructions, data, design rules, libraries of standard cells, and/or other parameters for processing by processor 902. The information is transferred to processor 902 via bus 908. EDA system 900 is configured to receive information related to a UI through I/O interface 910. The information is stored in computer-readable medium 904 as user interface (UI) 942.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by EDA system 900. In some embodiments, a layout diagram which includes standard cells is generated using a tool such as VIRTUOSO® available from CADENCE DESIGN SYSTEMS, Inc., or another suitable layout generating tool.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

FIG. 10 is a block diagram of an integrated circuit (IC) manufacturing system 1000, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using manufacturing system 1000.

In FIG. 10, IC manufacturing system 1000 includes entities, such as a design house 1020, a mask house 1030, and an IC manufacturer/fabricator (“fab”) 1050, that interact with one another in the design, development, and manufacturing cycles and/or services related to manufacturing an IC device 1060. The entities in system 1000 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 1020, mask house 1030, and IC fab 1050 is owned by a single larger company. In some embodiments, two or more of design house 1020, mask house 1030, and IC fab 1050 coexist in a common facility and use common resources.

Design house (or design team) 1020 generates an IC design layout diagram 1022. IC design layout diagram 1022 includes various geometrical patterns designed for an IC device 1060. The geometrical patterns correspond to patterns of metal, oxide, or semiconductor layers that make up the various components of IC device 1060 to be fabricated. The various layers combine to form various IC features. For example, a portion of IC design layout diagram 1022 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 1020 implements a proper design procedure to form IC design layout diagram 1022. The design procedure includes one or more of logic design, physical design or place-and-route operation. IC design layout diagram 1022 is presented in one or more data files having information of the geometrical patterns. For example, IC design layout diagram 1022 can be expressed in a GDSII file format or DFII file format.

Mask house 1030 includes data preparation 1032 and mask fabrication 1044. Mask house 1030 uses IC design layout diagram 1022 to manufacture one or more masks 1045 to be used for fabricating the various layers of IC device 1060 according to IC design layout diagram 1022. Mask house 1030 performs mask data preparation 1032, where IC design layout diagram 1022 is translated into a representative data file (“RDF”). Mask data preparation 1032 provides the RDF to mask fabrication 1044. Mask fabrication 1044 includes a mask writer. A mask writer converts the RDF to an image on a substrate, such as a mask (reticle) 1045 or a semiconductor wafer 1053. The design layout diagram 1022 is manipulated by mask data preparation 1032 to comply with particular characteristics of the mask writer and/or requirements of IC fab 1050. In FIG. 10, mask data preparation 1032 and mask fabrication 1044 are illustrated as separate elements. In some embodiments, mask data preparation 1032 and mask fabrication 1044 can be collectively referred to as mask data preparation.

In some embodiments, mask data preparation 1032 includes optical proximity correction (OPC) which uses lithography enhancement techniques to compensate for image errors, such as those that can arise from diffraction, interference, other process effects and the like. OPC adjusts IC design layout diagram 1022. In some embodiments, mask data preparation 1032 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 1032 includes a mask rule checker (MRC) that checks the IC design layout diagram 1022 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 1022 to compensate for limitations during mask fabrication 1044, which may undo part of the modifications performed by OPC in order to meet mask creation rules.

In some embodiments, mask data preparation 1032 includes lithography process checking (LPC) that simulates processing that will be implemented by IC fab 1050 to fabricate IC device 1060. LPC simulates this processing based on IC design layout diagram 1022 to create a simulated manufactured device, such as IC device 1060. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 1022.

It should be understood that the above description of mask data preparation 1032 has been simplified for the purposes of clarity. In some embodiments, data preparation 1032 includes additional features such as a logic operation (LOP) to modify the IC design layout diagram 1022 according to manufacturing rules. Additionally, the processes applied to IC design layout diagram 1022 during data preparation 1032 may be executed in a variety of different orders.

After mask data preparation 1032 and during mask fabrication 1044, a mask 1045 or a group of masks 1045 are fabricated based on the modified IC design layout diagram 1022. In some embodiments, mask fabrication 1044 includes performing one or more lithographic exposures based on IC design layout diagram 1022. In some embodiments, an electron-beam (e-beam) or a mechanism of multiple e-beams is used to form a pattern on a mask (photomask or reticle) 1045 based on the modified IC design layout diagram 1022. Mask 1045 can be formed in various technologies. In some embodiments, mask 1045 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of mask 1045 includes a transparent substrate (e.g., fused quartz) and an opaque material (e.g., chromium) coated in the opaque regions of the binary mask. In another example, mask 1045 is formed using a phase shift technology. In a phase shift mask (PSM) version of mask 1045, various features in the pattern formed on the phase shift mask are configured to have proper phase difference to enhance the resolution and imaging quality. In various examples, the phase shift mask can be attenuated PSM or alternating PSM. The mask(s) generated by mask fabrication 1044 is used in a variety of processes. For example, such a mask(s) is used in an ion implantation process to form various doped regions in semiconductor wafer 1053, in an etching process to form various etching regions in semiconductor wafer 1053, and/or in other suitable processes.

IC fab 1050 is an IC fabrication business that includes one or more manufacturing facilities for the fabrication of a variety of different IC products. In some embodiments, IC Fab 1050 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 1050 includes fabrication tools 1052 configured to execute various manufacturing operations on semiconductor wafer 1053 such that IC device 1060 is fabricated in accordance with the mask(s), e.g., mask 1045. In various embodiments, fabrication tools 1052 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 1050 uses mask(s) 1045 fabricated by mask house 1030 to fabricate IC device 1060. Thus, IC fab 1050 at least indirectly uses IC design layout diagram 1022 to fabricate IC device 1060. In some embodiments, semiconductor wafer 1053 is fabricated by IC fab 1050 using mask(s) 1045 to form IC device 1060. In some embodiments, the IC fabrication includes performing one or more lithographic exposures based at least indirectly on IC design layout diagram 1022. Semiconductor wafer 1053 includes a silicon substrate or other proper substrate having material layers formed thereon. Semiconductor wafer 1053 further includes one or more of various doped regions, dielectric features, multilevel interconnects, and the like (formed at subsequent manufacturing steps).

In some embodiments, a semiconductor device comprises a set of external connectors arranged in a plurality of columns and a plurality of rows. The set of external connectors comprises a plurality of receiver connectors and a plurality of transmitter connectors correspondingly configured to input and output information into and from the semiconductor device. The plurality of receiver connectors comprises: a first receiver connector group of first consecutive receiver connectors among the plurality of receiver connectors, and a second receiver connector group of second consecutive receiver connectors among the plurality of receiver connectors. The plurality of transmitter connectors comprises: a first transmitter connector group of first consecutive transmitter connectors among the plurality of transmitter connectors, and a second transmitter connector group of second consecutive transmitter connectors among the plurality of transmitter connectors. The first receiver connector group, the second receiver connector group, the first transmitter connector group, and the second transmitter connector group are arranged with respect to each other along a column direction of the plurality of columns.

In some embodiments, an integrated circuit (IC) device comprises a first die and a second die. Each of the first die and the second die comprises a set of external connectors arranged in a plurality of columns and a plurality of rows. The set of external connectors comprises a plurality of receiver connectors, a plurality of transmitter connectors, and a plurality of power external connectors. The plurality of receiver connectors comprises a first receiver connector group of first receiver connectors among the plurality of receiver connectors. The plurality of transmitter connectors comprises a first transmitter connector group of first transmitter connectors among the plurality of transmitter connectors. The plurality of power external connectors comprises, among the plurality of rows, a first full row of power external connectors between the first receiver connector group and the first transmitter connector group. The first receiver connectors of the first die are correspondingly coupled to the first transmitter connectors of the second die, and the first transmitter connectors of the first die are correspondingly coupled to the first receiver connectors of the second die.

A method in accordance with some embodiments is performed at least partially by at least one processor. The method comprises generating, based on a first bump map, a second bump map, and storing the second bump map in a non-transitory computer readable storage medium. The first bump map comprises a set of bumps arranged in a plurality of columns and a plurality of rows. The set of bumps comprises a plurality of receiver bumps and a plurality of transmitter bumps. The plurality of receiver bumps comprises: a first receiver bump group of first receiver bumps among the plurality of receiver bumps, and a second receiver bump group of second receiver bumps among the plurality of receiver bumps. The plurality of transmitter bumps comprises: a first transmitter bump group of first transmitter bumps among the plurality of transmitter bumps, and a second transmitter bump group of second transmitter bumps among the plurality of transmitter bumps. The plurality of rows comprises: a first set of rows in which the first receiver bumps are arranged, a second set of rows in which the second receiver bumps are arranged, a third set of rows in which the first transmitter bumps are arranged, and a fourth set of rows in which the second transmitter bumps are arranged. The first through fourth sets of rows are non-overlapping with each other. The generating the second bump map comprises: replicating, in the second bump map, the first set of rows in which the first receiver bumps are arranged and the third set of rows in which the first transmitter bumps are arranged, or disabling the second receiver bumps and the second transmitter bumps, to obtain the second bump map.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor device, comprising a set of external connectors arranged in a plurality of columns and a plurality of rows, wherein
the set of external connectors comprises a plurality of receiver connectors and a plurality of transmitter connectors correspondingly configured to input and output information into and from the semiconductor device,
the plurality of receiver connectors comprises:
a first receiver connector group of first consecutive receiver connectors among the plurality of receiver connectors, and
a second receiver connector group of second consecutive receiver connectors among the plurality of receiver connectors,
the plurality of transmitter connectors comprises:
a first transmitter connector group of first consecutive transmitter connectors among the plurality of transmitter connectors, and
a second transmitter connector group of second consecutive transmitter connectors among the plurality of transmitter connectors,
the first receiver connector group, the second receiver connector group, the first transmitter connector group, and the second transmitter connector group are arranged with respect to each other along a column direction of the plurality of columns.

2. The semiconductor device of claim 1, wherein
the plurality of rows comprises:
a first set of rows in which the first consecutive receiver connectors are arranged,
a second set of rows in which the second consecutive receiver connectors are arranged,
a third set of rows in which the first consecutive transmitter connectors are arranged, and
a fourth set of rows in which the second consecutive transmitter connectors are arranged, and
the first through fourth sets of rows are non-overlapping with each other.

3. The semiconductor device of claim 1, wherein
the first consecutive receiver connectors correspond to the first consecutive transmitter connectors, and
the second consecutive receiver connectors correspond to the second consecutive transmitter connectors.

4. The semiconductor device of claim 1, wherein
the second transmitter connector group, the first transmitter connector group, the first receiver connector group, and the second receiver connector group are arranged in the recited order along the column direction.

5. The semiconductor device of claim 1, wherein
the second consecutive receiver connectors are consecutive to the first consecutive receiver connectors, and
the second consecutive transmitter connectors are consecutive to the first consecutive transmitter connectors.

6. The semiconductor device of claim 1, wherein
the set of external connectors further comprises a plurality of power external connectors, and
the plurality of power external connectors comprises, among the plurality of rows,
at least one row of power external connectors between each pair of adjacent groups among the first receiver connector group, the second receiver connector group, the first transmitter connector group, and the second transmitter connector group, and
two end rows of power external connectors between which the first receiver connector group, the second receiver connector group, the first transmitter connector group, and the second transmitter connector group are arranged.

7. The semiconductor device of claim 1, wherein
the set of external connectors further comprises:
a plurality of power supply external connectors, and
a plurality of ground external connectors,
the plurality of power supply external connectors comprises, among the plurality of rows,
at least one full row of power supply external connectors between each pair of adjacent groups among the first receiver connector group, the second receiver connector group, the first transmitter connector group, and the second transmitter connector group, and
two end rows of power supply external connectors between which the first receiver connector group, the second receiver connector group, the first transmitter connector group, and the second transmitter connector group are arranged, and
the plurality of ground external connectors comprises, among the plurality of rows, in
at least one full row of ground external connectors between each said pair of adjacent groups, and
two end rows of ground external connectors between which the first receiver connector group, the second receiver connector group, the first transmitter connector group, and the second transmitter connector group are arranged.

8. The semiconductor device of claim 1, wherein
the set of external connectors further comprises a plurality of clock external connectors arranged along one or more central columns among the plurality of columns.

9. The semiconductor device of claim 1, wherein
the second consecutive receiver connectors and the second consecutive transmitter connectors are disabled.

10. The semiconductor device of claim 1, wherein
the set of external connectors corresponds to the Universal Chiplet Interconnect Express (UCIe) protocol, and
each of the first receiver connector group, the second receiver connector group, the first transmitter connector group, and the second transmitter connector group includes exactly 32 consecutive main band data external connectors.

11. An integrated circuit (IC) device, comprising a first die and a second die, wherein
each of the first die and the second die comprises a set of external connectors arranged in a plurality of columns and a plurality of rows,
the set of external connectors comprises a plurality of receiver connectors, a plurality of transmitter connectors, and a plurality of power external connectors,
the plurality of receiver connectors comprises a first receiver connector group of first receiver connectors among the plurality of receiver connectors,
the plurality of transmitter connectors comprises a first transmitter connector group of first transmitter connectors among the plurality of transmitter connectors, and
the plurality of power external connectors comprises, among the plurality of rows, a first full row of power external connectors between the first receiver connector group and the first transmitter connector group,
the first receiver connectors of the first die are correspondingly coupled to the first transmitter connectors of the second die, and
the first transmitter connectors of the first die are correspondingly coupled to the first receiver connectors of the second die.

12. The IC device of claim 11, wherein
in the first die,
the plurality of receiver connectors further comprises a second receiver connector group of second receiver connectors among the plurality of receiver connectors,
the plurality of transmitter connectors further comprises a second transmitter connector group of second transmitter connectors among the plurality of transmitter connectors,
the first receiver connector group is arranged, along a column direction of the plurality of columns, between the second receiver connector group and the first transmitter connector group,
the first transmitter connector group is arranged, along the column direction, between the second transmitter connector group and the first receiver connector group,
the plurality of power external connectors further comprises:
a second full row of power external connectors between the first receiver connector group and the second receiver connector group,
a third full row of power external connectors between the first transmitter connector group and the second transmitter connector group, and
two full end rows of power external connectors between which the first receiver connector group, the second receiver connector group, the first transmitter connector group, and the second transmitter connector group are arranged.

13. The IC device of claim 12, wherein
the second receiver connectors and the second transmitter connectors of the first die are not coupled to the plurality of external connectors of the second die.

14. The IC device of claim 12, wherein
in the second die,
the plurality of receiver connectors further comprises a second receiver connector group of second receiver connectors among the plurality of receiver connectors,
the plurality of transmitter connectors further comprises a second transmitter connector group of second transmitter connectors among the plurality of transmitter connectors,
the first receiver connector group is arranged, along a column direction of the plurality of columns, between the second receiver connector group and the first transmitter connector group,
the first transmitter connector group is arranged, along the column direction, between the second transmitter connector group and the first receiver connector group,
the plurality of power external connectors further comprises:
a second full row of power external connectors between the first receiver connector group and the second receiver connector group,
a third full row of power external connectors between the first transmitter connector group and the second transmitter connector group, and
two full end rows of power external connectors between which the first receiver connector group, the second receiver connector group, the first transmitter connector group, and the second transmitter connector group are arranged.

15. The IC device of claim 14, wherein
the second receiver connectors and the second transmitter connectors of the first die are not coupled to the plurality of external connectors of the second die, and
the second receiver connectors and the second transmitter connectors of the second die are not coupled to the plurality of external connectors of the first die.

16. The IC device of claim 14, wherein
the second receiver connectors of the first die are correspondingly coupled to the second transmitter connectors of the second die, and
the second transmitter connectors of the first die are correspondingly coupled to the second receiver connectors of the second die.

17. The IC device of claim 11, wherein
in each of the first die and the second die,
the set of external connectors corresponds to the Universal Chiplet Interconnect Express (UCIe) protocol, and
each of the first receiver connector group and the first transmitter connector group includes exactly 32 consecutive main band data external connectors.

18. A method performed at least partially by at least one processor, the method comprising:
generating, based on a first bump map, a second bump map; and
storing the second bump map in a non-transitory computer readable storage medium, wherein
the first bump map comprises a set of bumps arranged in a plurality of columns and a plurality of rows,
the set of bumps comprises a plurality of receiver bumps and a plurality of transmitter bumps,
the plurality of receiver bumps comprises:
a first receiver bump group of first receiver bumps among the plurality of receiver bumps, and
a second receiver bump group of second receiver bumps among the plurality of receiver bumps,
the plurality of transmitter bumps comprises:
a first transmitter bump group of first transmitter bumps among the plurality of transmitter bumps, and
a second transmitter bump group of second transmitter bumps among the plurality of transmitter bumps,
the plurality of rows comprises:
a first set of rows in which the first receiver bumps are arranged,
a second set of rows in which the second receiver bumps are arranged,
a third set of rows in which the first transmitter bumps are arranged, and
a fourth set of rows in which the second transmitter bumps are arranged,
the first through fourth sets of rows are non-overlapping with each other, and
said generating comprises:
replicating, in the second bump map, the first set of rows in which the first receiver bumps are arranged and the third set of rows in which the first transmitter bumps are arranged, or
disabling the second receiver bumps and the second transmitter bumps, to obtain the second bump map.

19. The method of claim 18, further comprising:
based on the first bump map and the second bump map, controlling manufacture of an integrated circuit (IC) device, wherein
the IC device comprises a first die, a second die, and an interconnect structure,
the first die comprises a first input/output (I/O) port corresponding to the first bump map,
the second die comprises a second I/O port corresponding to the second bump map,
the first receiver bumps in the first I/O port of the first die are correspondingly coupled, by the interconnect structure, to the first transmitter bumps in the second I/O port of the second die, and
the first transmitter bumps in the first I/O port of the first die are correspondingly coupled, by the interconnect structure, to the first receiver bumps in the second I/O port of the second die.

20. The method of claim 18, wherein
the first bump map corresponds to the Universal Chiplet Interconnect Express (UCIe) protocol, and includes exactly 64 main band data bumps corresponding to the first receiver bumps, the second receiver bumps, the first transmitter bumps and the second transmitter bumps in the first bump map, and
the second bump map corresponds to the UCIe protocol, and includes exactly 32 main band data bumps corresponding to the first receiver bumps and the first transmitter bumps in the second bump map.
